(19) United States
(12) Patent Application Publication
(10) Pub. No.: US 2005/0010516 A1
(43) Pub. Date: Jan. 13, 2005

(54) Dynamic rebalancing of assets in an investment portfolio

(75) Inventors: Ivo V. Ivanov, Stamford, CT (US); Dirk Alvin Roper, Rohnert Park, CA (US); Wayne Patrick Ferbert, Ellicott City, MD (US)

Correspondence Address: MILES & STOCKBRIDGE PC, 1751 PINNACLE DRIVE, SUITE 500, MCLEAN, VA, 22102-3833, US

(73) Assignee: Ameritrade Holding Corporation, Jersey City, NJ (US)

(21) Appl. No.: 10/777,093

(22) Filed: Feb. 13, 2004

Related U.S. Application Data
(60) Provisional application No. 60/447,005, filed on Feb. 13, 2003.

(51) Int. Cl. G06F 17/60

(52) U.S. Cl. 705/36

(57) ABSTRACT

An portfolio investment management system comprising an asset allocation strategy recommendation module adapted to receive investment goal information and investor risk tolerance level information from a user, the investment goal information including at least one of an initial investment amount or estimated contributions, and an estimated withdrawal target date, the asset allocation strategy recommendation module determining a percentage allocation for a plurality of asset classes. The portfolio investment management system further comprises an asset allocation strategy execution module adapted to execute the determined asset allocation strategy. The portfolio investment management system also comprises a rebalancing execution module adapted to automatically rebalance the portfolio upon a predetermined condition without any further input from the user. The portfolio is automatically rebalanced without any further input from the user.

### RELATED APPLICATION DATA

This application claims the benefit of U.S. Provisional Patent Application No. 60/447,005, filed Feb. 13, 2003, entitled “Asset Management System and Method,” which is herein incorporated by reference in its entirety.

### FIELD OF THE INVENTION

The present invention generally relates to investment portfolio management. In particular, the present invention relates to automatically rebalancing the allocation of assets according to investment goals and other criteria.

### BACKGROUND

In general, it is desirable for an investor to diversify the assets in an investment portfolio so as to optimize the mix of risk and return. The term “asset allocation” is used to describe the distribution of assets among a variety of financial products in order to provide the desired balance of risk and return for the investment portfolio. For example, equities generally provide a higher potential return on investment than bonds, but at a higher risk of potential loss. Therefore, an investor who is planning for the short term is well advised to have an asset allocation with more bonds than an investor who is investing for the long term.

The number of financial products available to individual investors has grown dramatically in recent years, resulting in many individuals being overwhelmed by the information and choices offered to them. To assist investors, financial services companies have developed systems to help individuals select the most appropriate financial products to meet their needs. These systems typically perform analysis based upon mathematical models regarding retirement planning and investment alternatives, for example.

Investment advisory services utilize asset allocation methodologies, in many cases using commercial portfolio optimization software, to recommend specific market segment or “asset-class” allocations. The systems typically use asset allocation models to recommend allocation percentages among classes of financial products. These types of known systems may provide generic asset allocation suggestions, and leave the investor to find the actual combination of financial products that meet the suggested asset allocation.

When an investor sets up an investment portfolio using conventional asset allocation recommendations, the initial investment is allocated among several financial products according to a specified asset allocation model. As time passes, the percentage of the investor's assets in each investment class is likely to diverge from the initial allocation. For example, after a “bull” year, the increase in value of an investor's equities is likely to exceed the increase in value of the investor's bonds. As a result, the percentage of the investor's assets in equities will be higher than the initial allocation, and the percentage of assets in bonds will be lower than the initial allocation.

To maintain a preferred asset allocation among various financial products in a portfolio, investors should re-evaluate a portfolio's risk and return balance on a periodic basis. This re-evaluation may result in the investor re-allocating the portfolio's assets. This re-evaluation and re-allocation is commonly referred to as “rebalancing.” In the example given above, a “rebalancing” of the investment portfolio will cause some of the investor's equities to be sold and additional bonds to be purchased so as to restore the portfolio mix to appropriate percentages consistent with the investor's asset allocation strategy.

The re-balancing of an investment portfolio is generally a manual process. During the rebalancing process, the investor, or the investor's adviser, determines whether the allocation of assets within a portfolio still matches the initial suggested asset allocation parameters. If the allocation of assets no longer falls within the preferred asset allocation parameters, the asset allocation has “drifted”, and therefore a reallocation of assets is indicated. During a reallocation, the investor, or the investor's advisor, identifies assets to sell in order to purchase assets of another class that will bring the portfolio back into balance.

Although known investment advisory systems can provide an investor with some guidance as to a recommended asset allocation for a portfolio, they rely on the investor to make the actual purchases and sales to create or rebalance a portfolio. A method and system for automatically creating an investment portfolio would be advantageous. A method and system for automatically rebalancing a portfolio would be advantageous. A method and system for automatically determining a new recommended asset allocation strategy due to changes in a portfolio or in an investor's circumstances would be advantageous. A method of automatically creating or rebalancing a portfolio that takes the initial or current holdings into consideration would be advantageous. A method of creating or rebalancing a portfolio that is tax aware would be advantageous. The method and system of the present invention provides all of these advantages and more.

### SUMMARY OF THE INVENTION

Accordingly, exemplary aspects of the present invention relate to allocating assets within an investment portfolio.

Additional aspects of the present invention relate to rebalancing asset allocation within an investment portfolio.

Additional aspects of the invention relate to creating an investment portfolio that takes into account initial asset holdings when creating a balanced investment portfolio.

Further aspects of the invention relate to rebalancing an investment portfolio taking into consideration additional infusions of funds into the portfolio and changes to investment goals as well as asset allocation drift.

Still further aspects of the invention relate to rebalancing an investment portfolio taking into account tax consequences.

Additional aspects of the invention relate to automatically rebalancing an investment portfolio.

Further aspect, features and advantages of the invention are described in, or are apparent from, the following detailed description.

### BRIEF DESCRIPTION OF THE DRAWINGS

Exemplary embodiments of the invention will be described in detail, with reference to the following figures, wherein:

FIG. 1 is a high level block chart of basic processes performed by a system of the present invention;

FIG. 2 illustrates an exemplary interface for defining a financial goal for an investor user within a system of the present invention;

FIG. 3 illustrates an exemplary interface for determining an investor user's risk tolerance level according to the present invention;

FIGS. 4A-4H illustrate an exemplary interface for a risk tolerance questionnaire;

FIG. 5 illustrates an exemplary interface for obtaining additional investor user information relating to a portfolio;

FIG. 6 illustrates an exemplary interface for obtaining portfolio funding information from an investor user;

FIG. 7 illustrates an exemplary interface for presenting a recommended portfolio asset allocation to an investor user of a system of the present invention;

FIG. 8 illustrates an exemplary interface for allowing an investor user to execute the recommended asset allocation strategy;

FIG. 9 illustrates an exemplary interface for analyzing tax consequences of creating a portfolio according to the asset allocation parameters recommended by a system of the present invention;

FIG. 10 illustrates an exemplary order ticket preview interface according to the present invention;

FIG. 7 illustrates an exemplary order confirmation interface according to the present invention;

FIG. 8 illustrates an exemplary interface for recommending specific financial products to be purchased in order to obtain the recommended asset allocation strategy for a portfolio;

FIG. 9 illustrates an exemplary interface for presenting potential tax consequences of creating the recommended portfolio to the investor user;

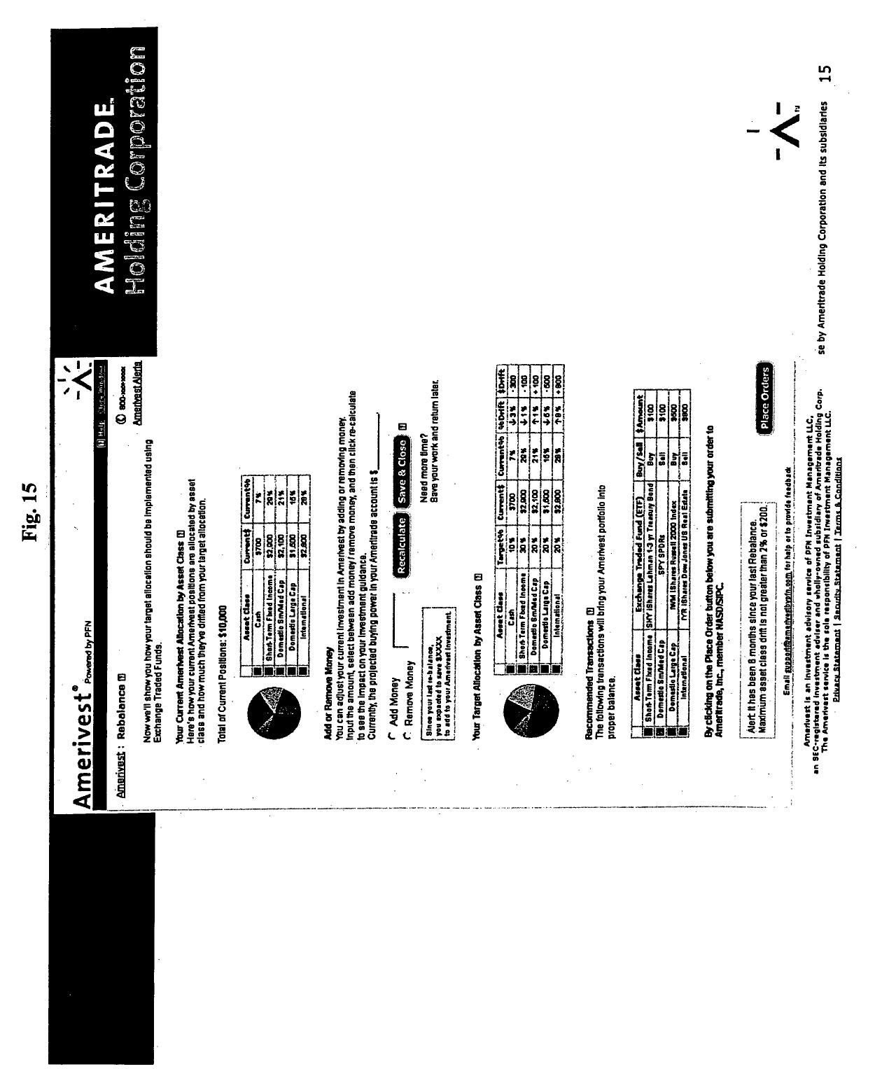

FIG. 10 illustrates an exemplary trading ticket created for a recommended asset allocation;

FIG. 11 illustrates an exemplary optional order receipt interface;

FIG. 12 illustrates an exemplary interface that may be presented to an investor when managing his portfolio;

FIG. 13 illustrates an exemplary interface for rebalancing a portfolio according to the present invention;

FIG. 14 illustrates an alternative exemplary interface for rebalancing a portfolio according to the present invention;

FIG. 15 illustrates an alternative exemplary interface for displaying portfolio drift;

FIG. 16 illustrates an alternative exemplary monitoring and portfolio management interface;

FIG. 17 illustrates an exemplary interface for managing multiple goals according to one embodiment of the present invention;

FIG. 18 illustrates an exemplary interface for an investor to invest additional funds into a portfolio according to the present invention;

FIG. 19 illustrates an exemplary interface for withdrawing funds from a portfolio; and

FIG. 20 illustrates an exemplary interface for monitoring the performance of a portfolio according to a system of the present invention.

### DETAILED DESCRIPTION

The exemplary systems and methods of this invention will be described in relation to an asset allocation management system. However, to avoid unnecessarily obscuring the present invention, the following description omits well-known structures and devices that may be shown in block diagram form or otherwise summarized. For the purpose of explanation, numerous specific details are set forth in order to provide a thorough understanding of the present invention. It should be appreciated however that the present invention may be practiced in a variety of ways beyond the specific details set forth herein. For example, while the systems and methods of this invention will be discussed in relation to conventional Modern Portfolio Theory, it should be appreciated that the system can be adapted to use any method of calculating optimal asset allocation.

Furthermore, it is to be appreciated that the various components of the system can be located at distant portions of a distributed network, such as a telecommunications network and/or the Internet, or within a dedicated investment advisory system. Thus, it should be appreciated that the various components illustrated herein can be combined into one or more devices or collocated on a particular node of a distributed network, such as a telecommunications network, the Internet, a private network, a secured or unsecured network or any combination thereof. It will be appreciated from the following description, and for reasons of computational efficiency, that the components of the inventive system can be arranged in any location within a distributed network without affecting the operation of the system.

Furthermore, it should be appreciated that the various links connecting the elements can be wired or wireless links, or any combination thereof, or any other known or latter developed element(s) that is capable of supplying and/or communicating data to and from the connected elements. Additionally, the term module as used herein can refer to any known or later developed hardware, software or combination of hardware and software that is capable of performing the functionality associated with that element.

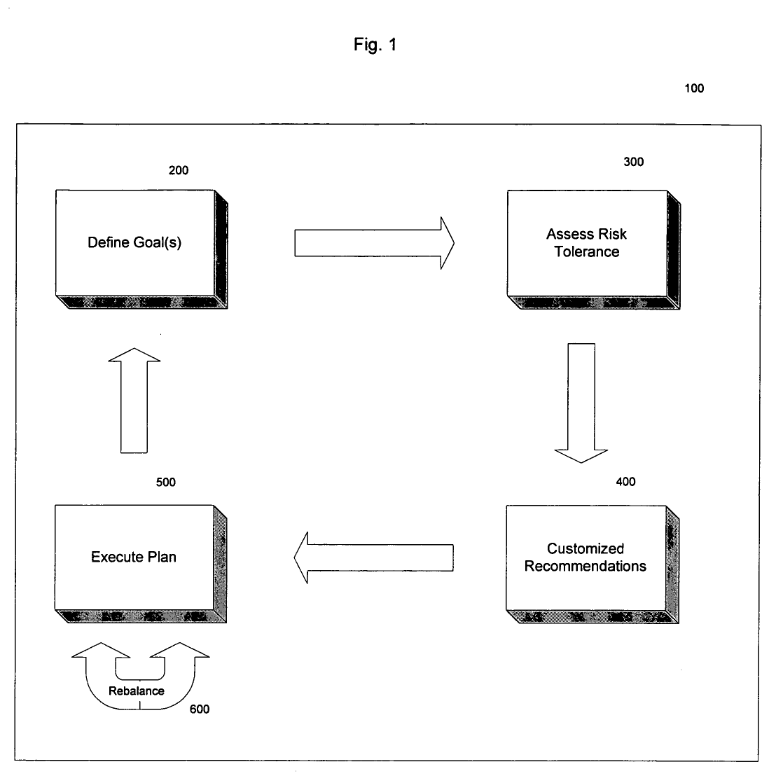

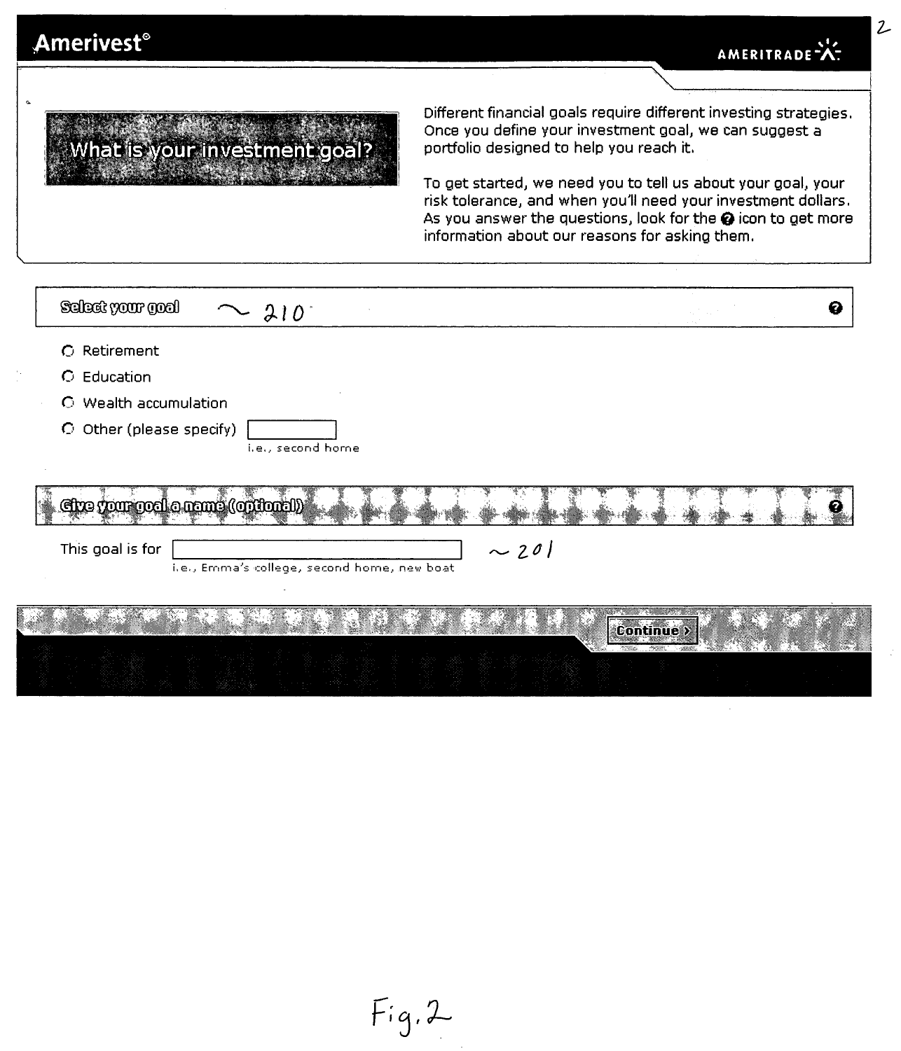

FIG. 1 illustrates a high level view of the process 100 used by a system according to the present invention. As shown, at block 200 an investor defines his investment goal(s) for a portfolio. At block 300, the risk tolerance of the investor is assessed. Investment portfolio recommendations customized to the investor's goals and risk tolerance level are determined at block 400. The customized investment plan is executed at block 500.

The embodiment of inventive process of FIG. 1 is shown to be circular. This is to indicate that the process can be re-executed. Process 100 may be re-executed on a specific recurring schedule, such as yearly. Alternatively, it may be re-executed when an investor's goals change or when there are changes in an investor's circumstances that would change the parameters in subprocesses 200 and 300 that are used by the system to calculate the customized portfolio allocation.

In one embodiment, the subprocesses of process 100 are performed only once. In this embodiment, the arrow between subprocess 500 and subprocess 200 would be eliminated.

In a preferred embodiment, as shown in FIG. 1, subprocess 500 is repeated on a recurring periodic basis, as shown by “rebalancing” arrow 600. As will be described in detail below, rebalancing the portfolio periodically helps to correct any portfolio drift that may have occurred. In one embodiment, portfolio rebalancing 600 may be manually initiated by the investor.

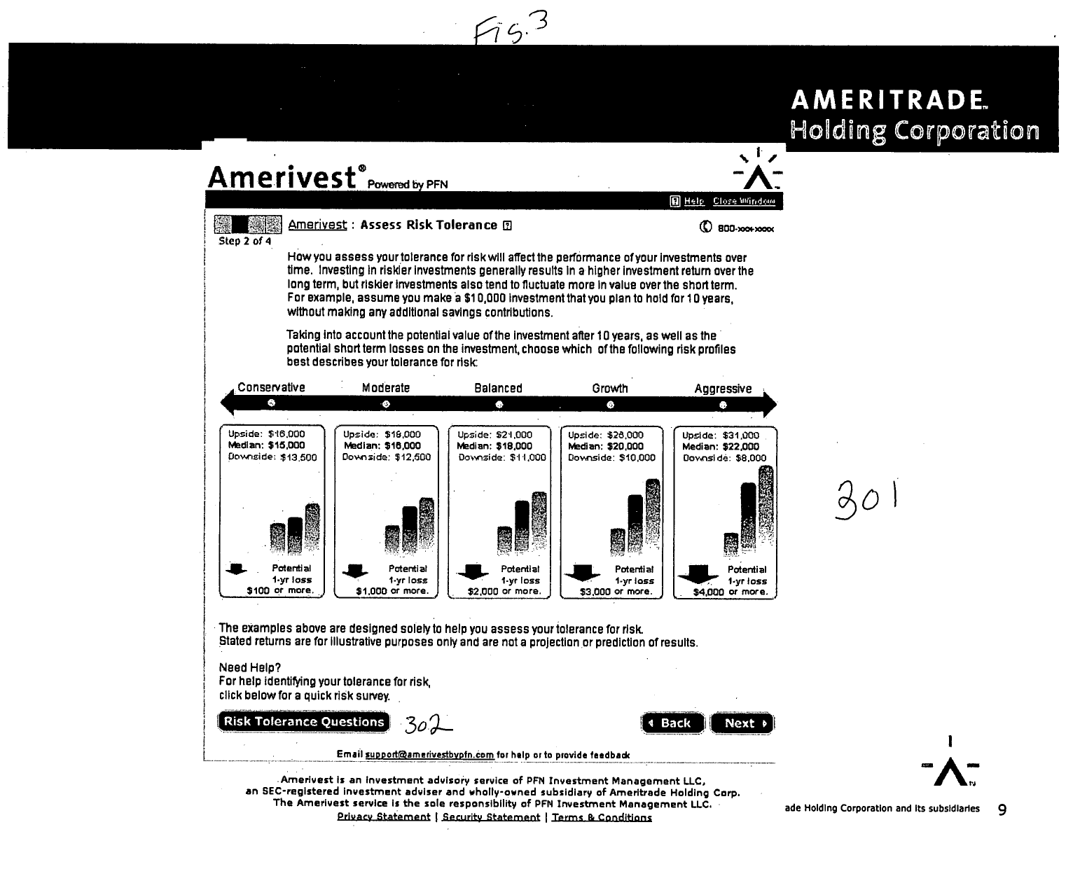

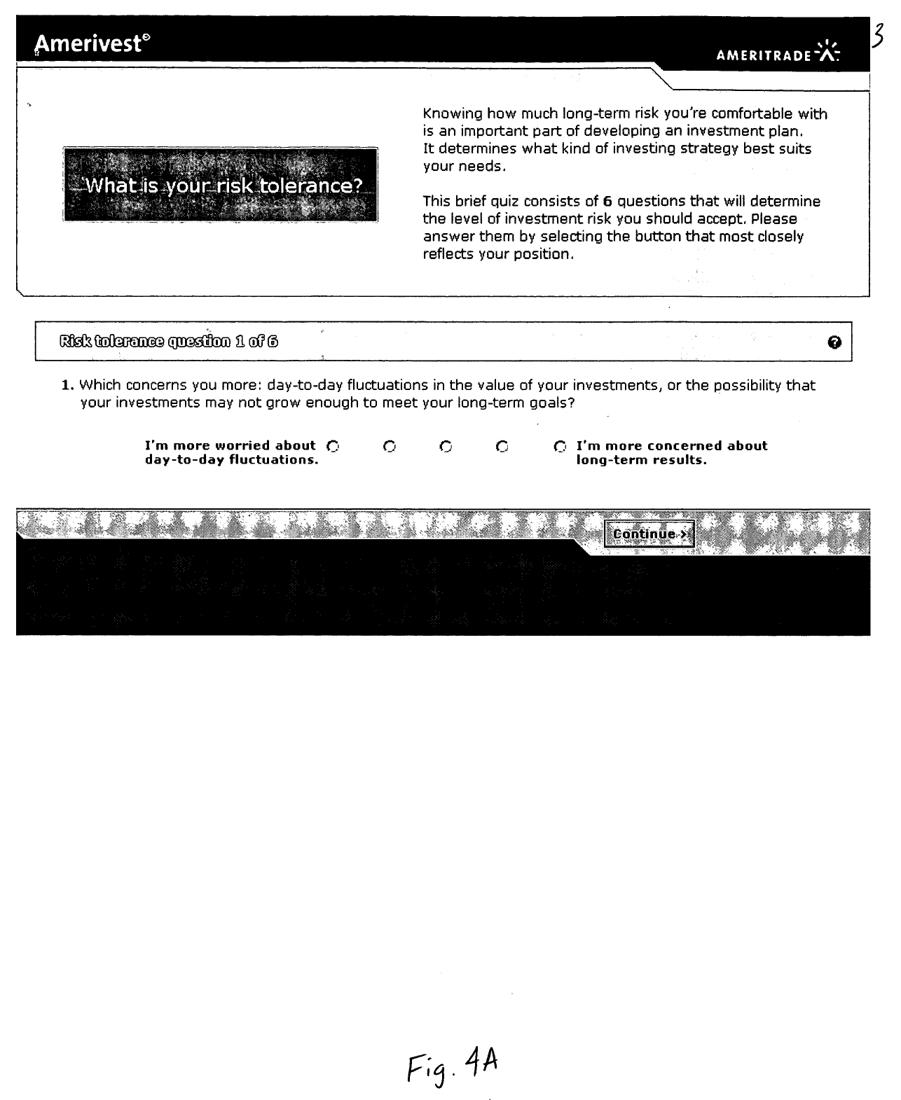

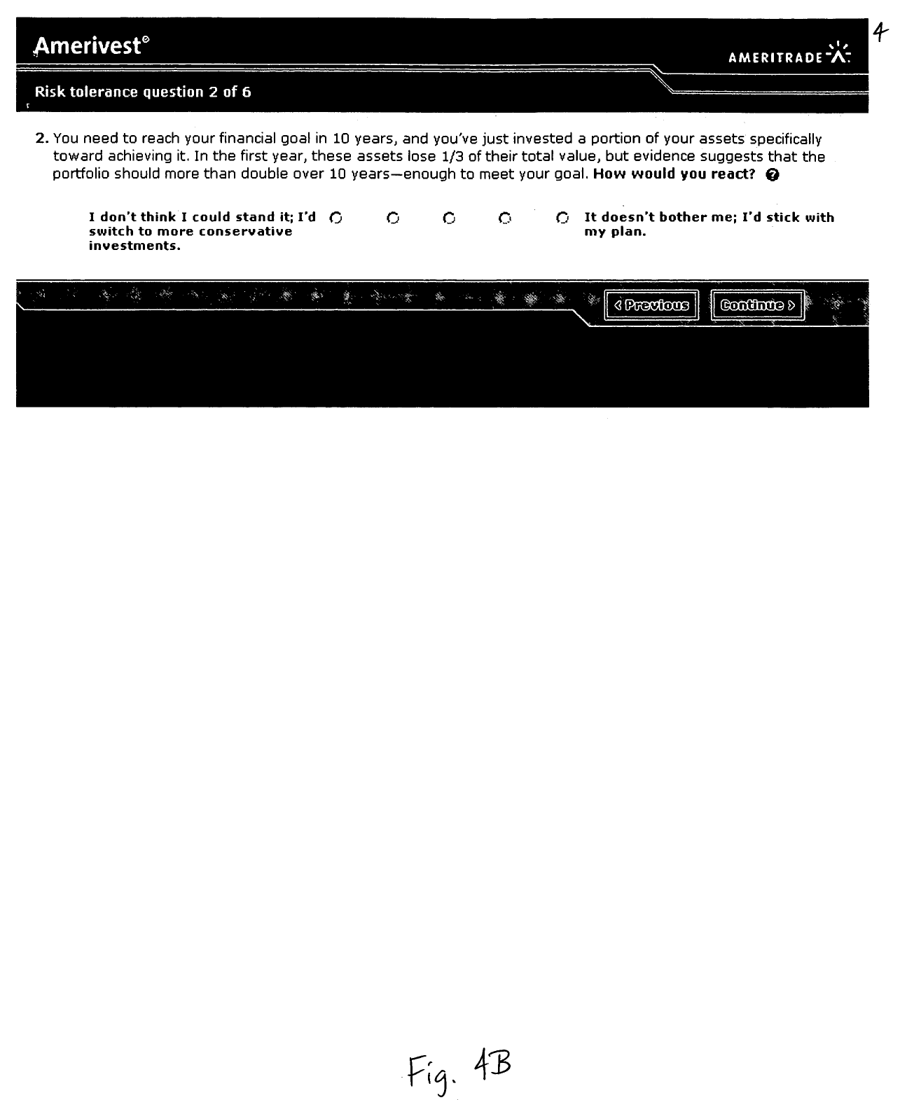

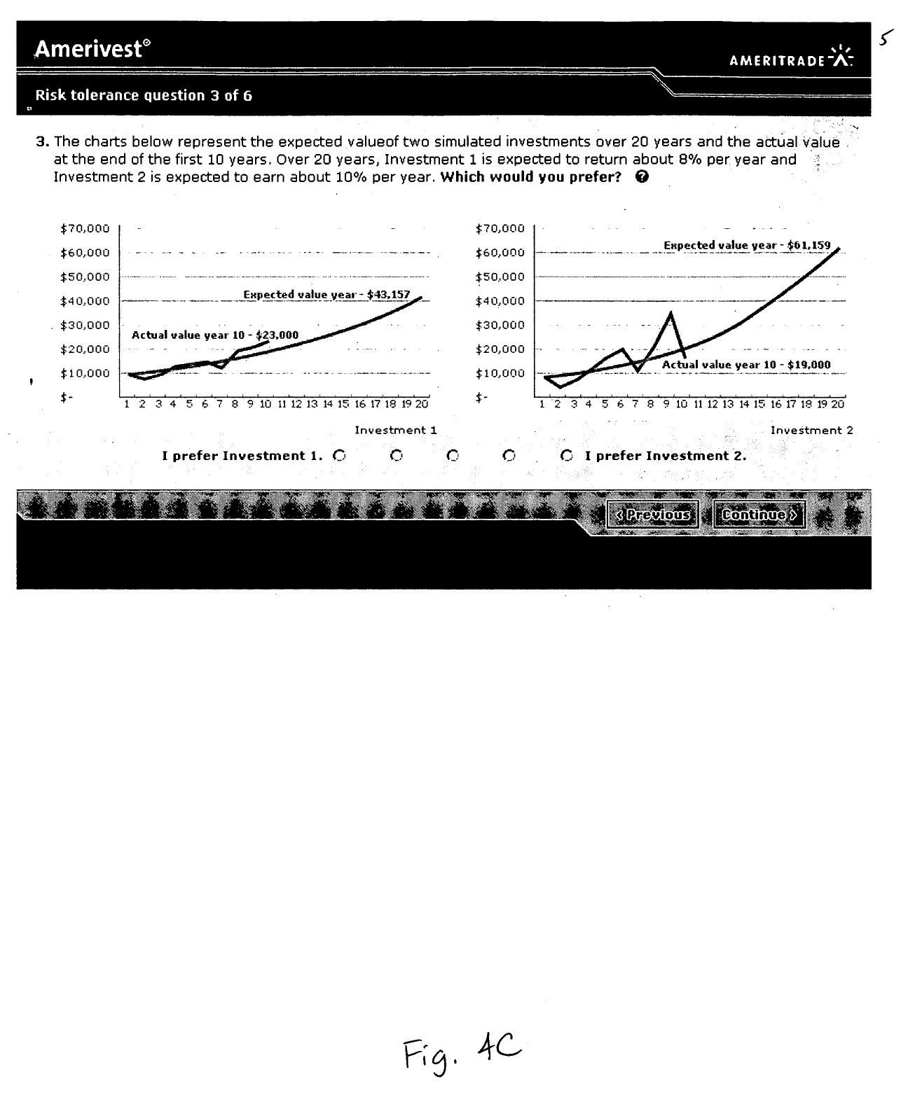

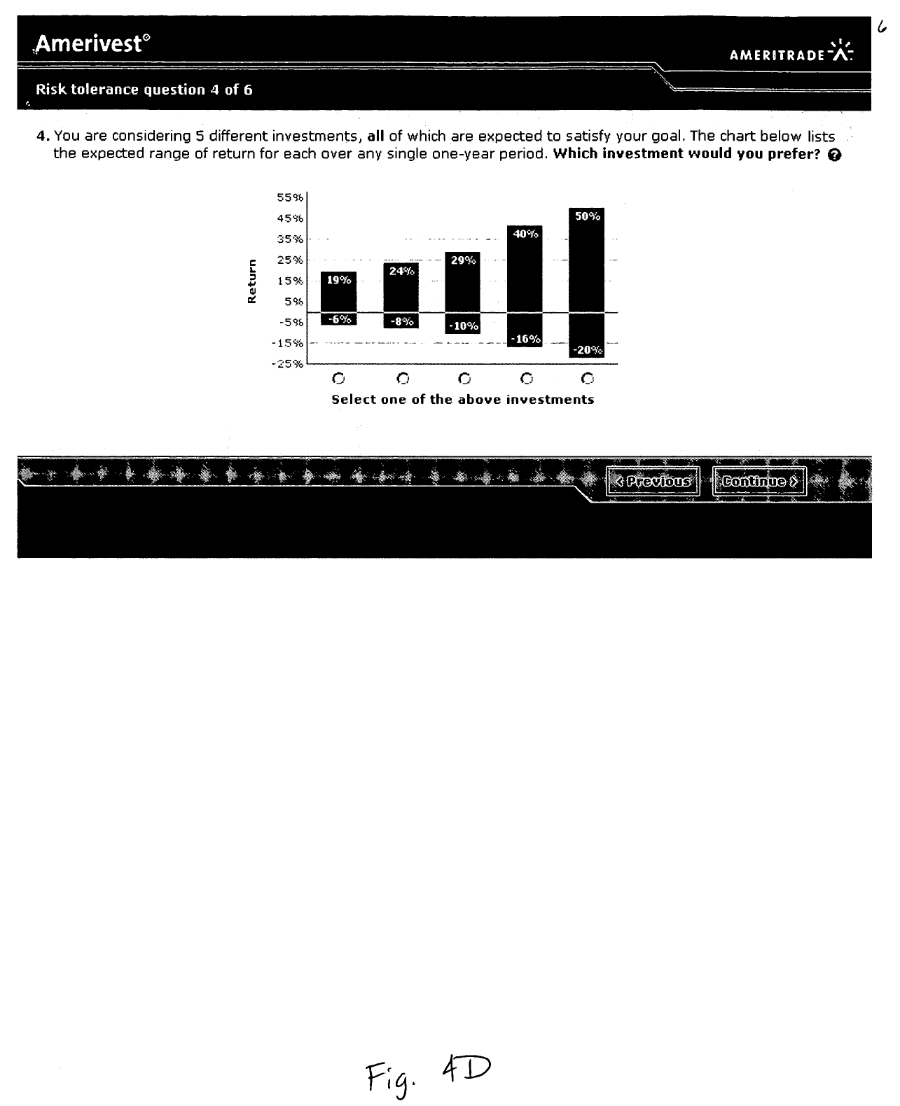

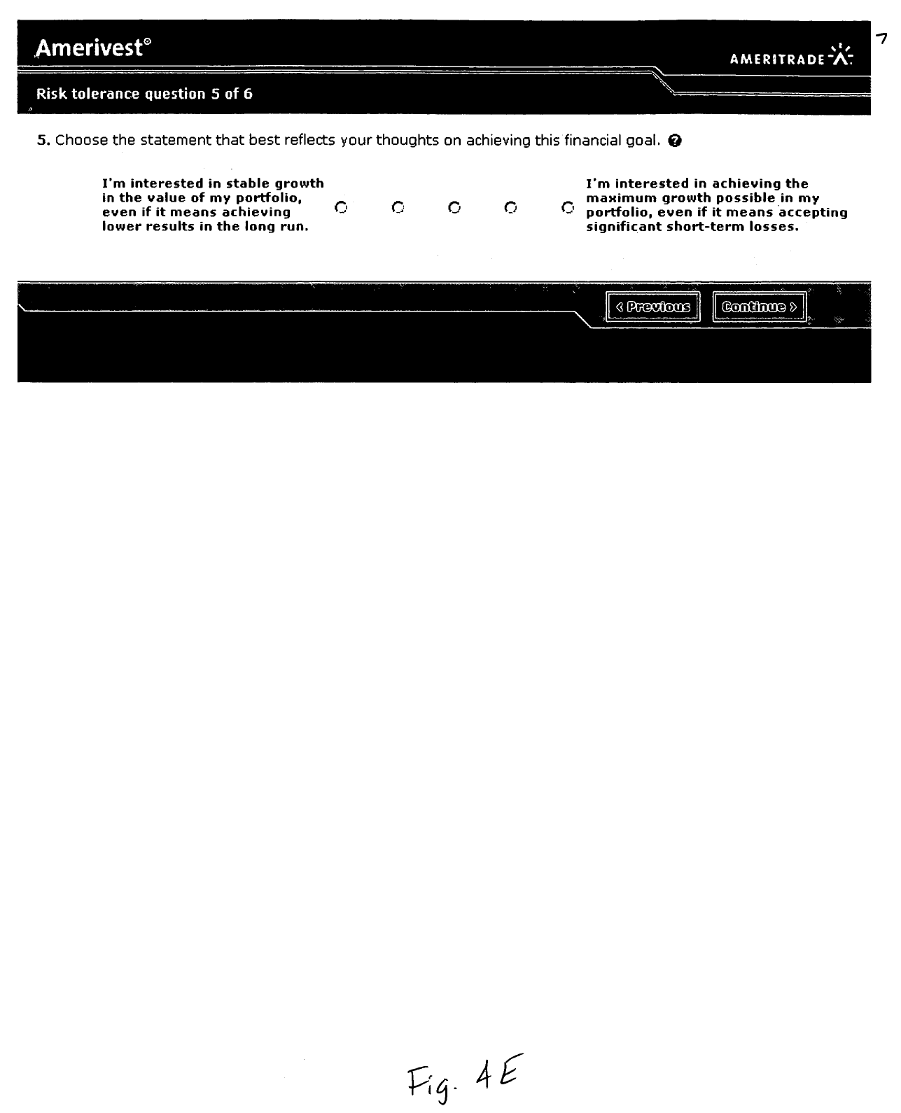

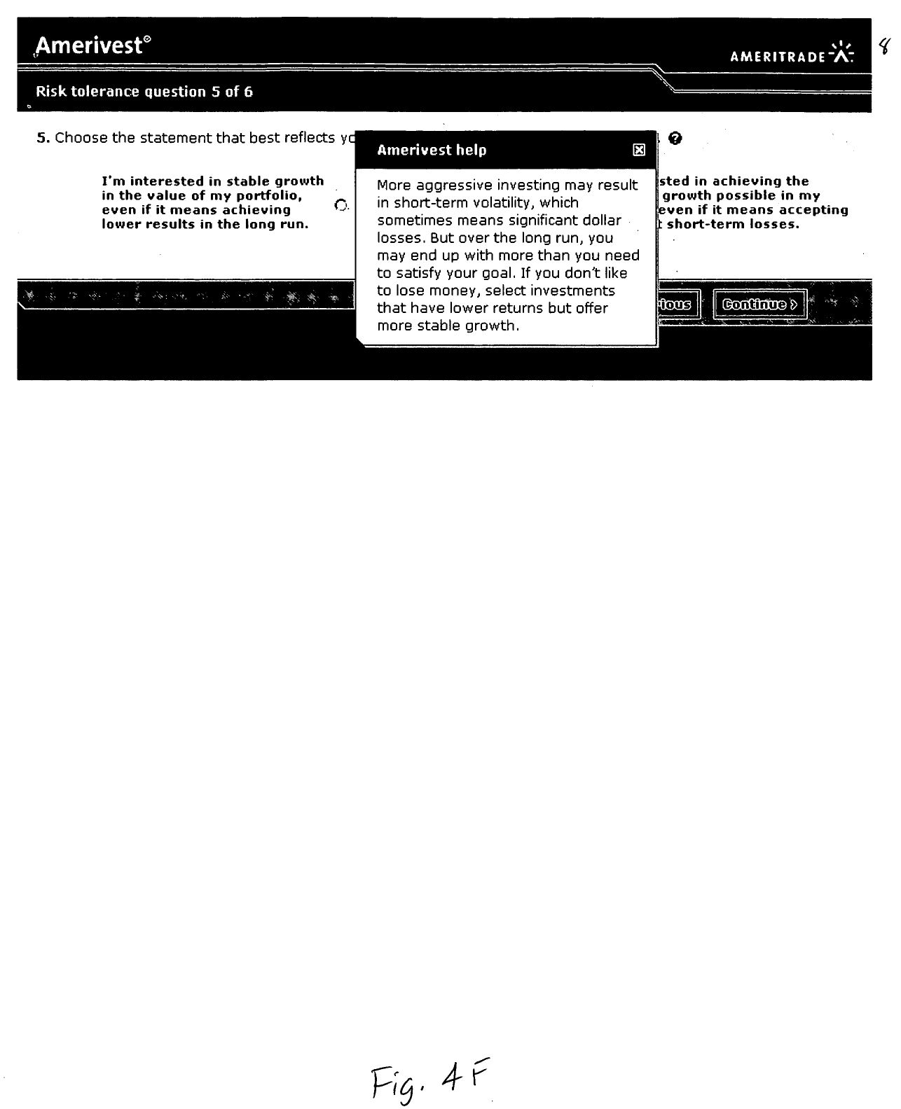

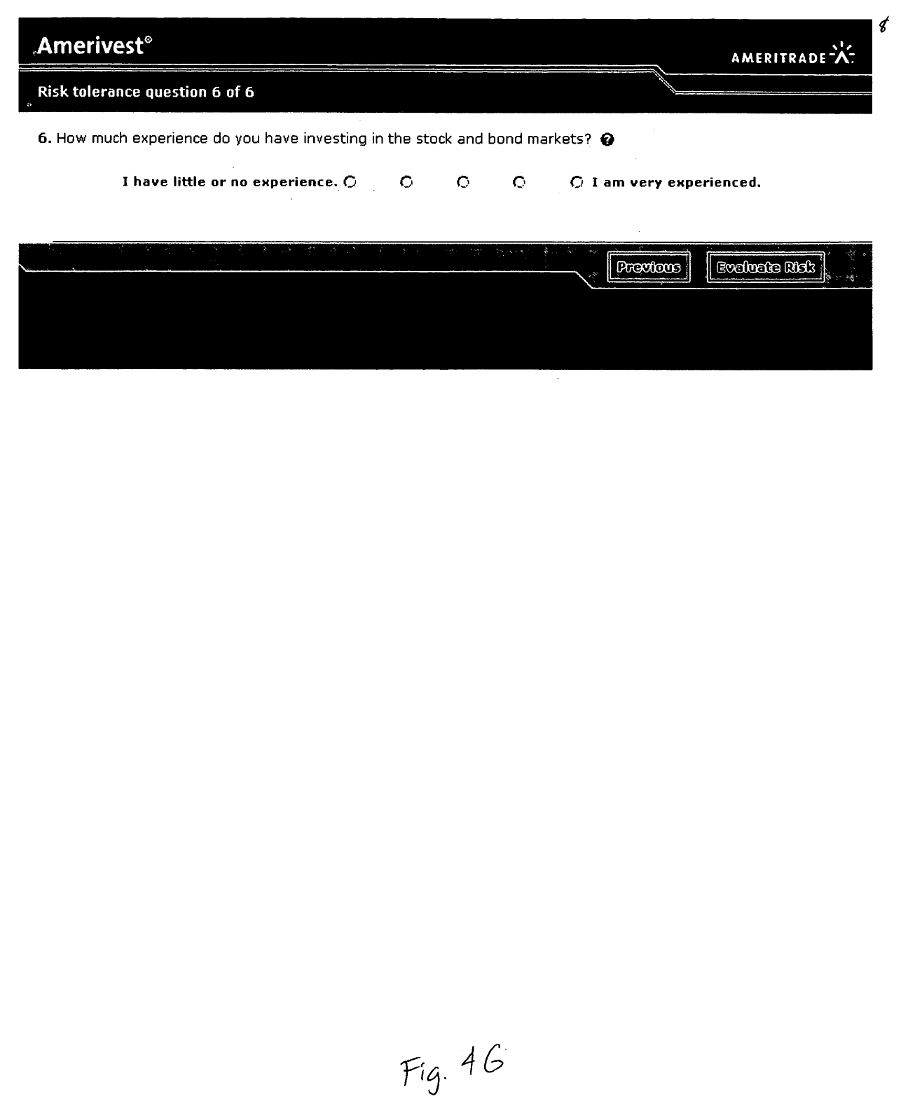

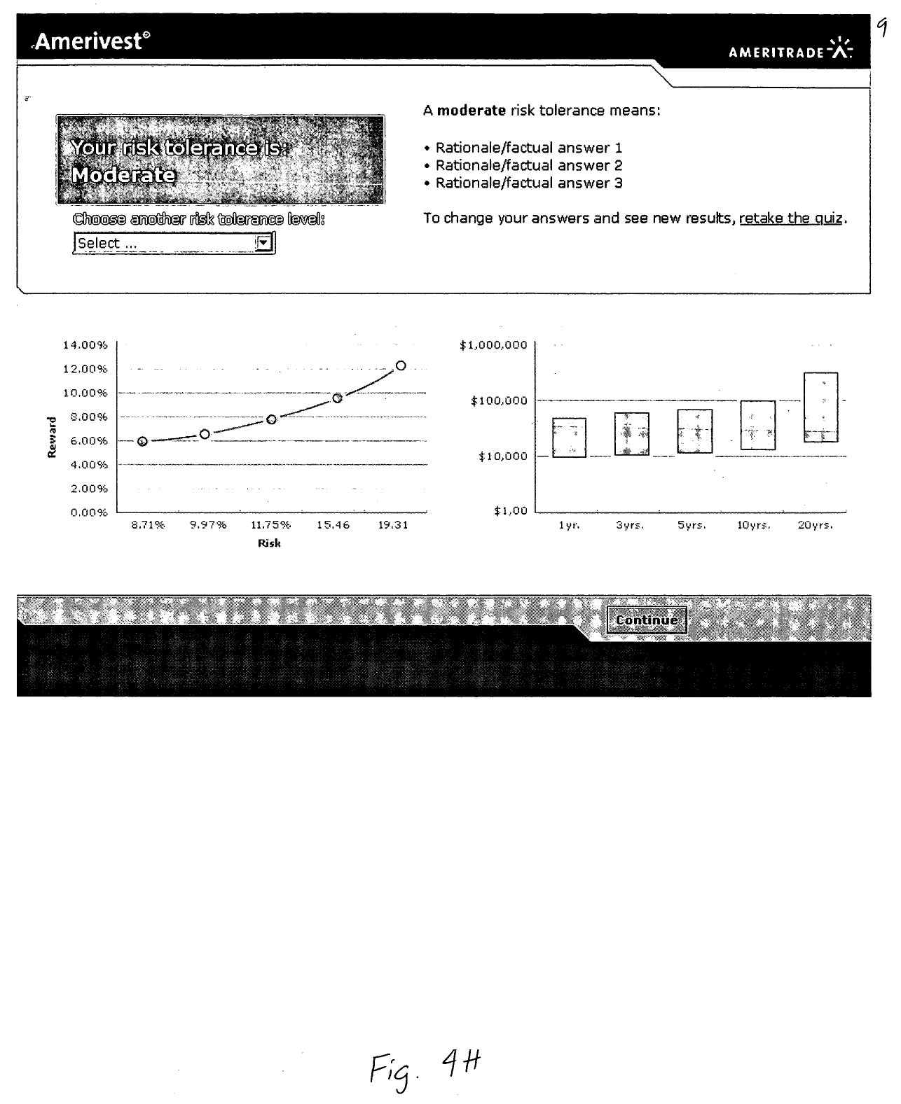

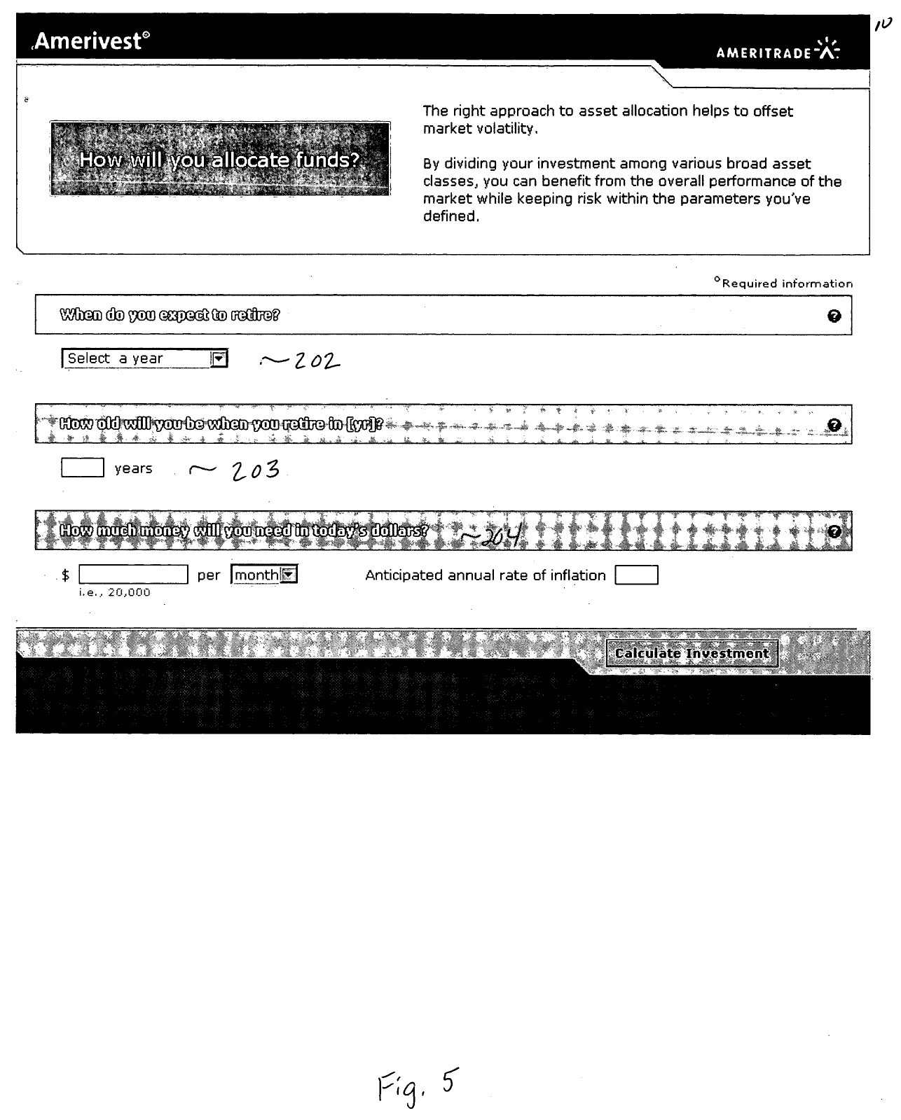

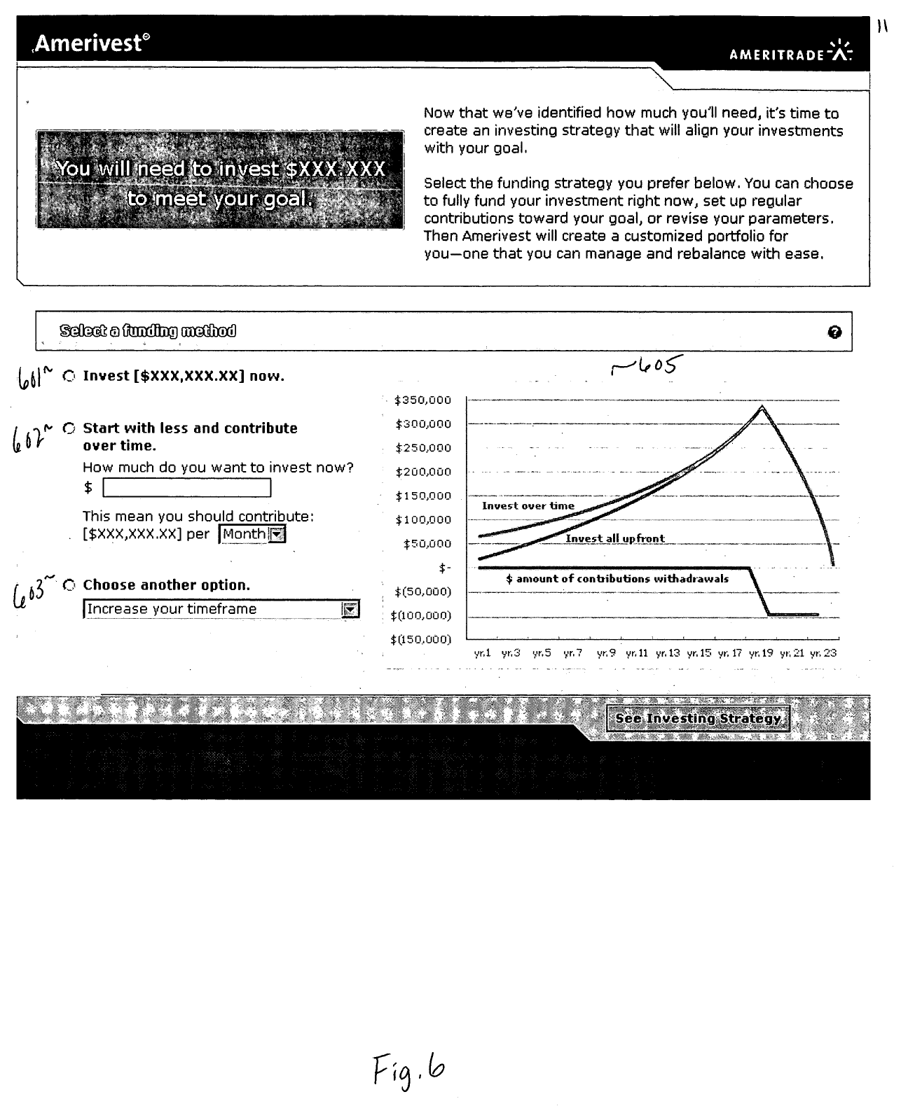

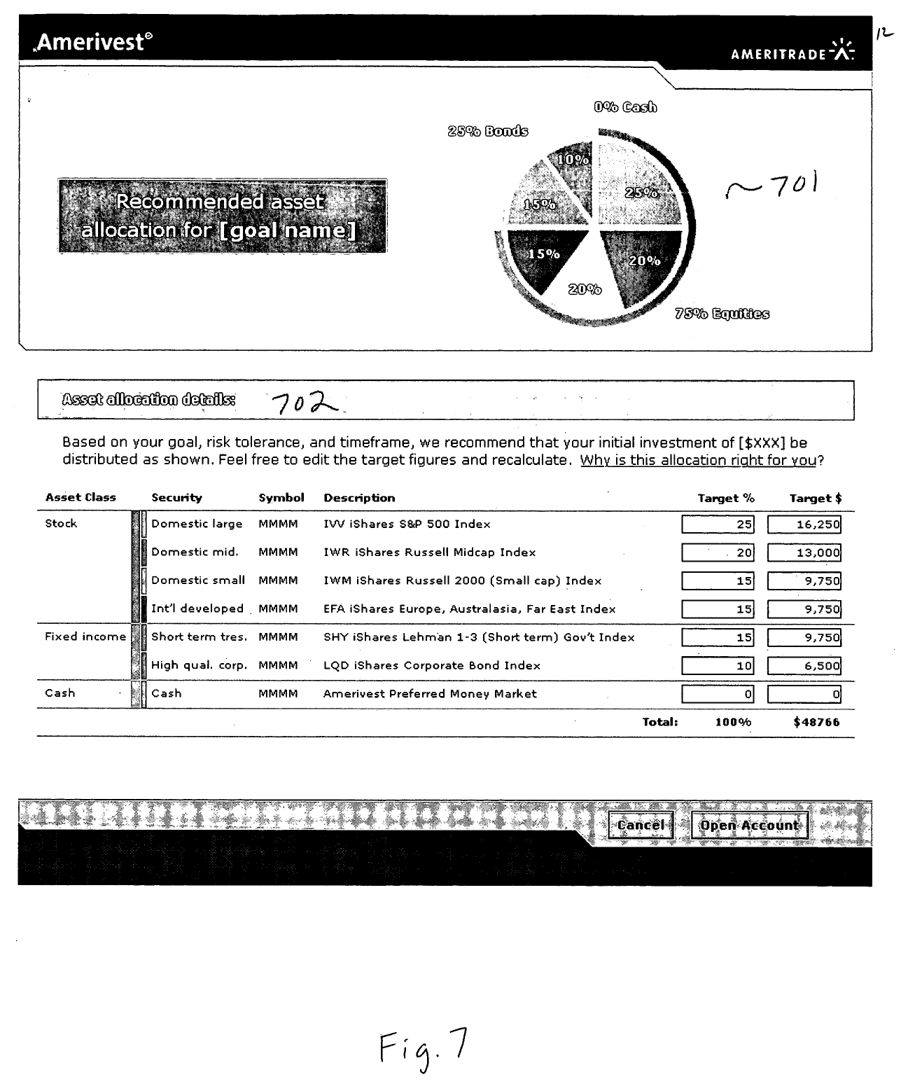

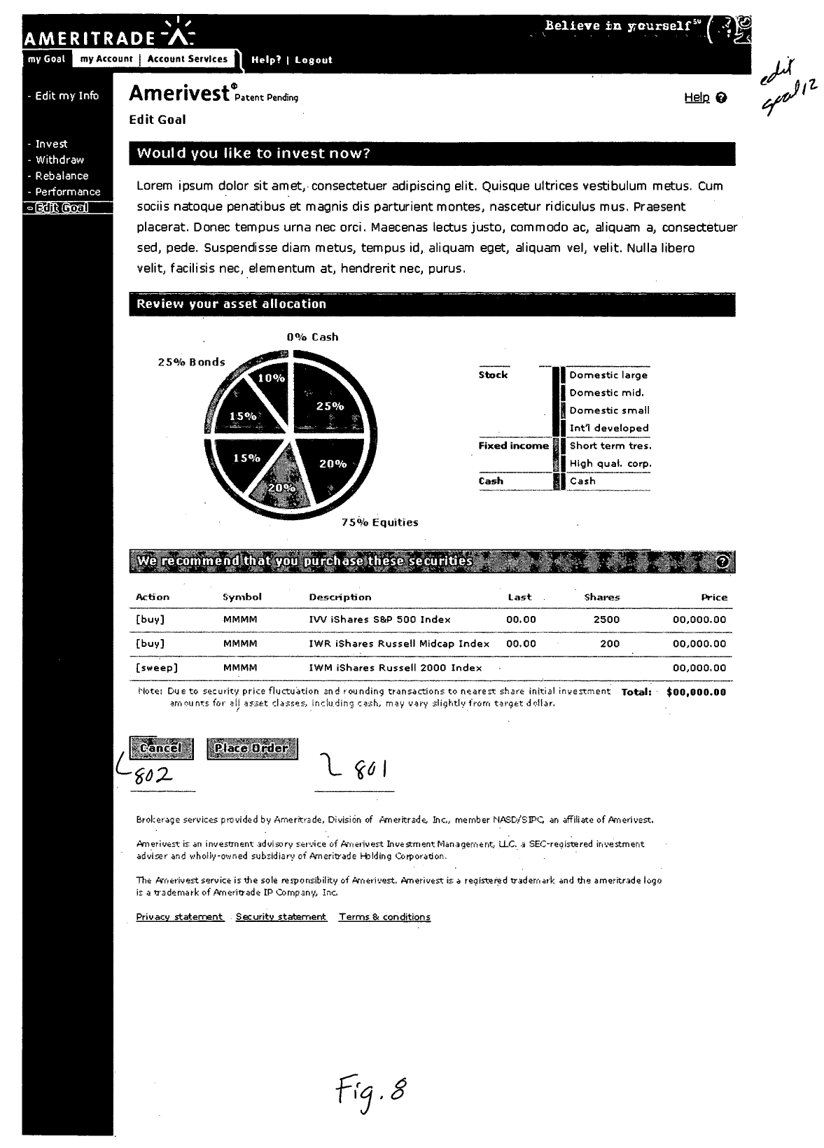

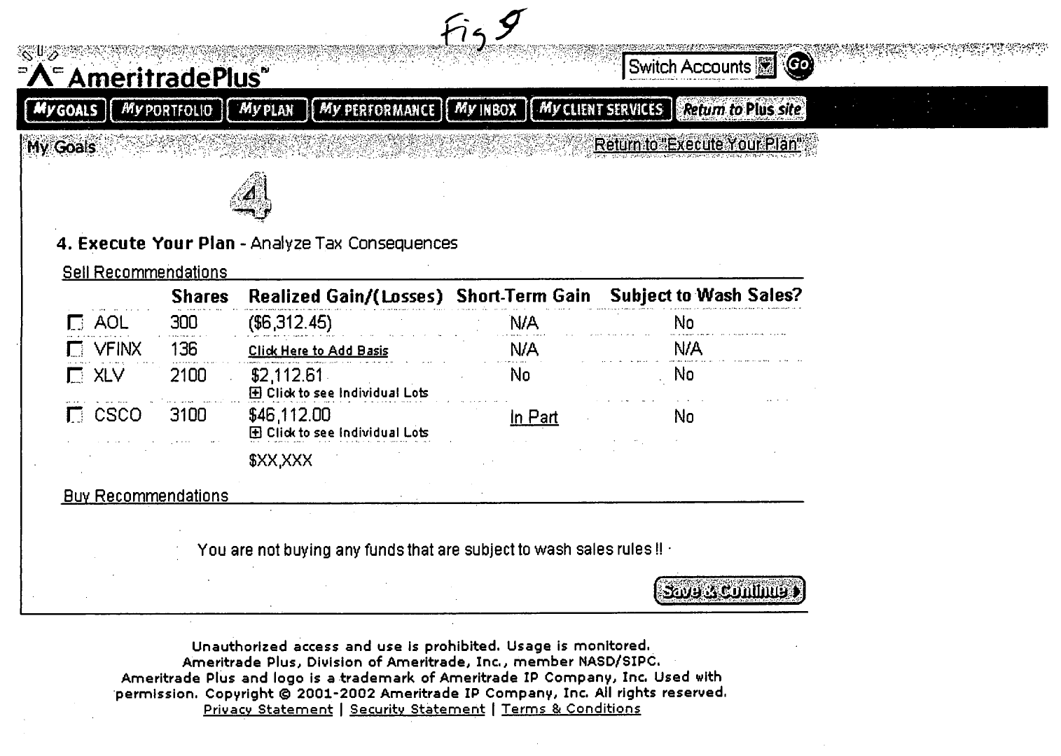

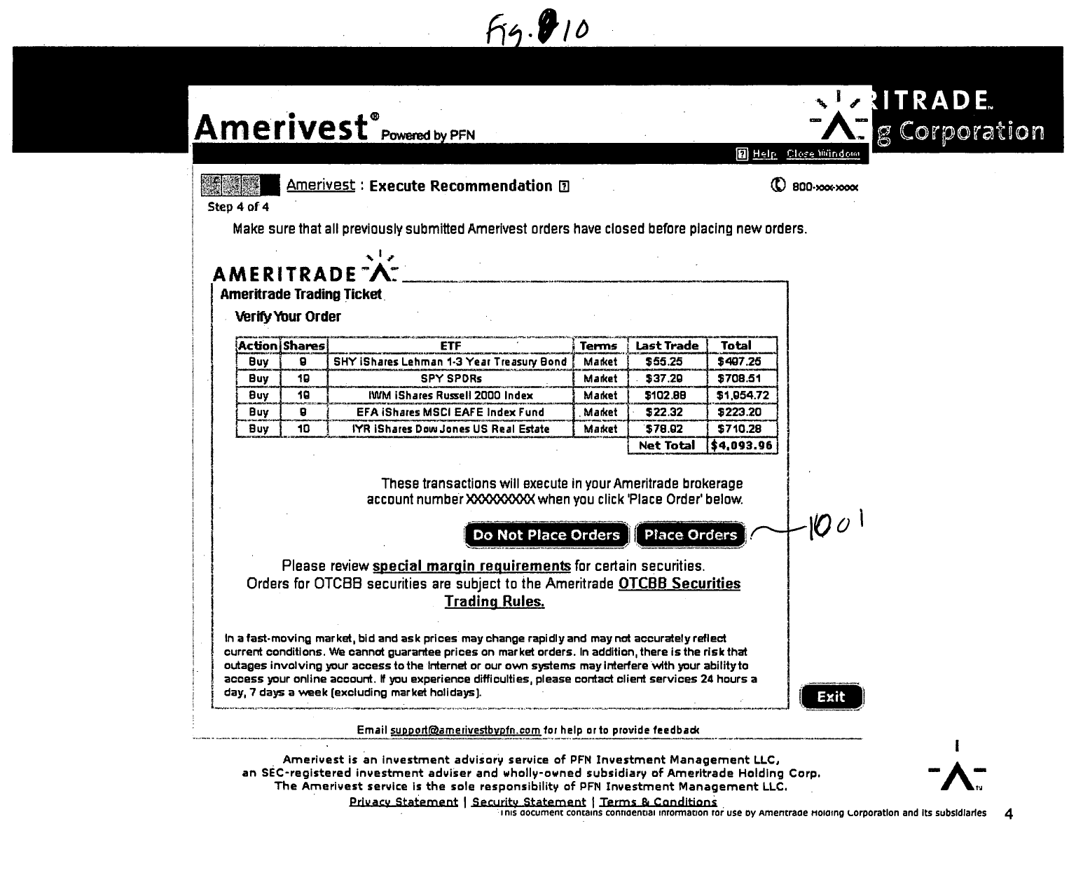

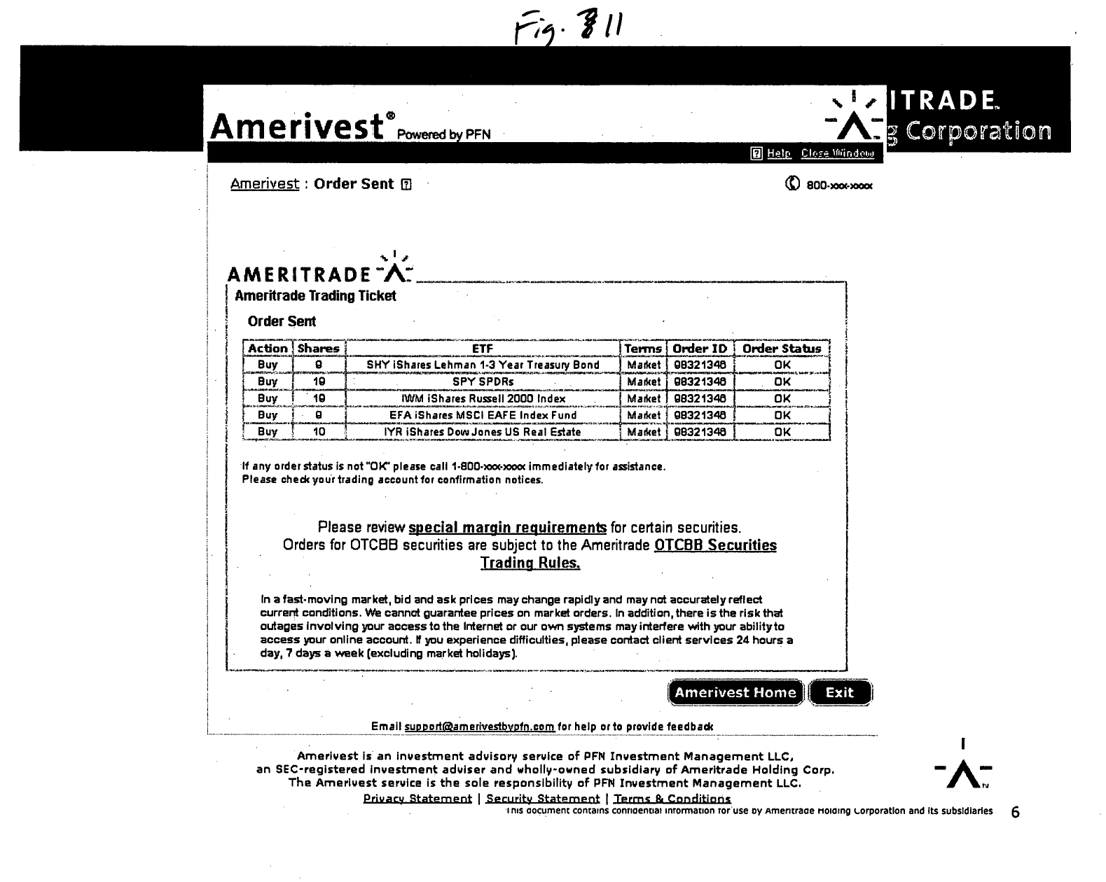

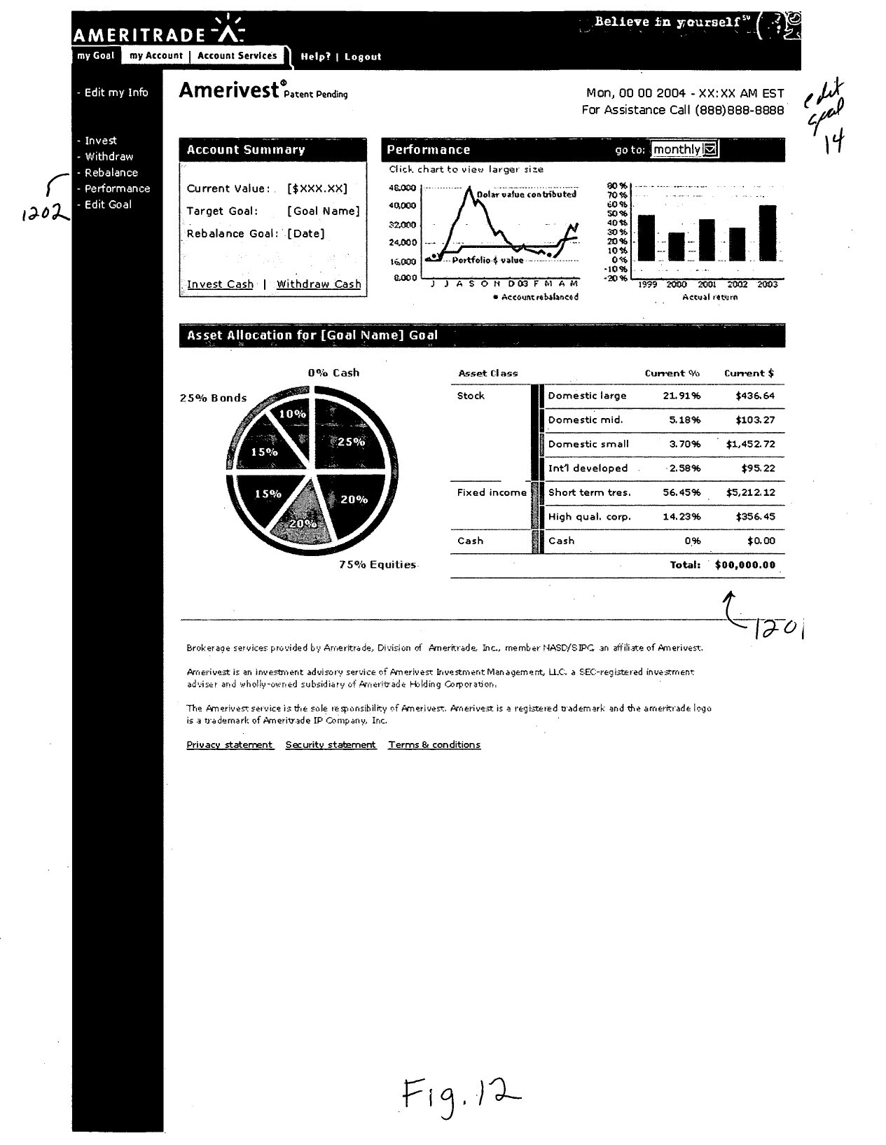

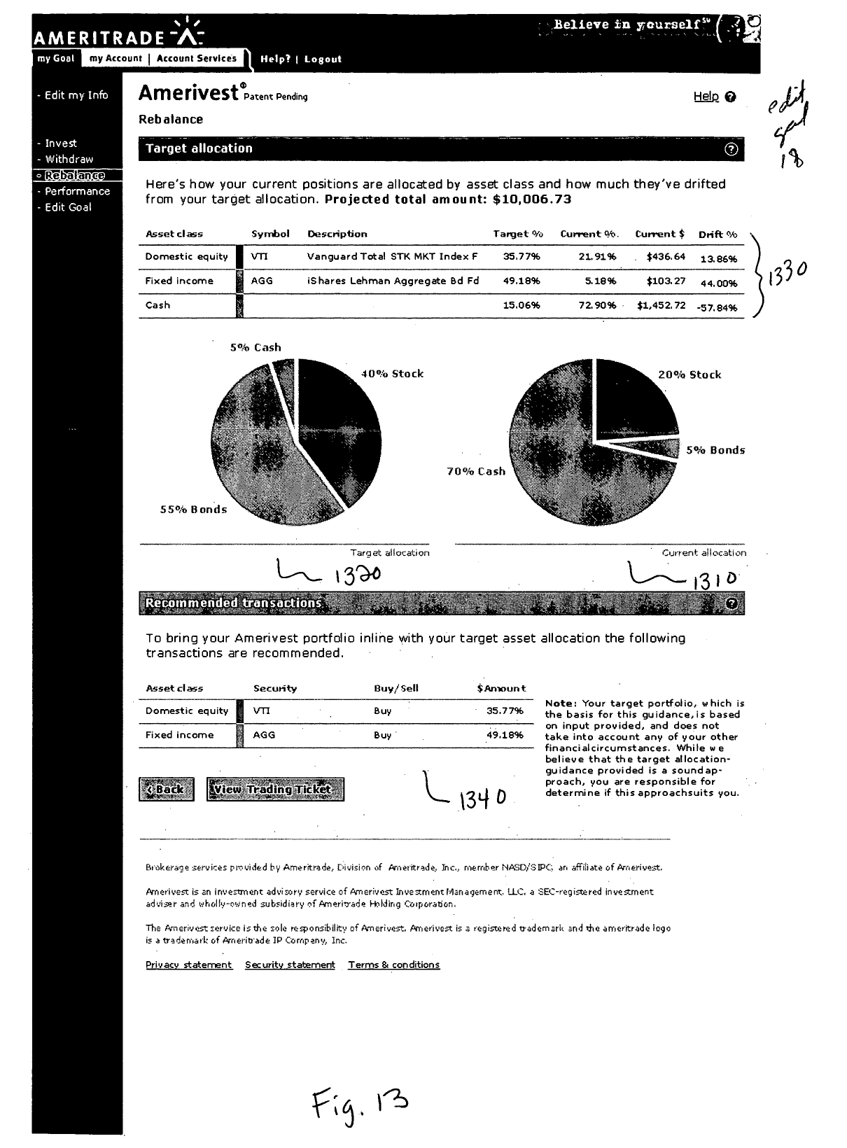

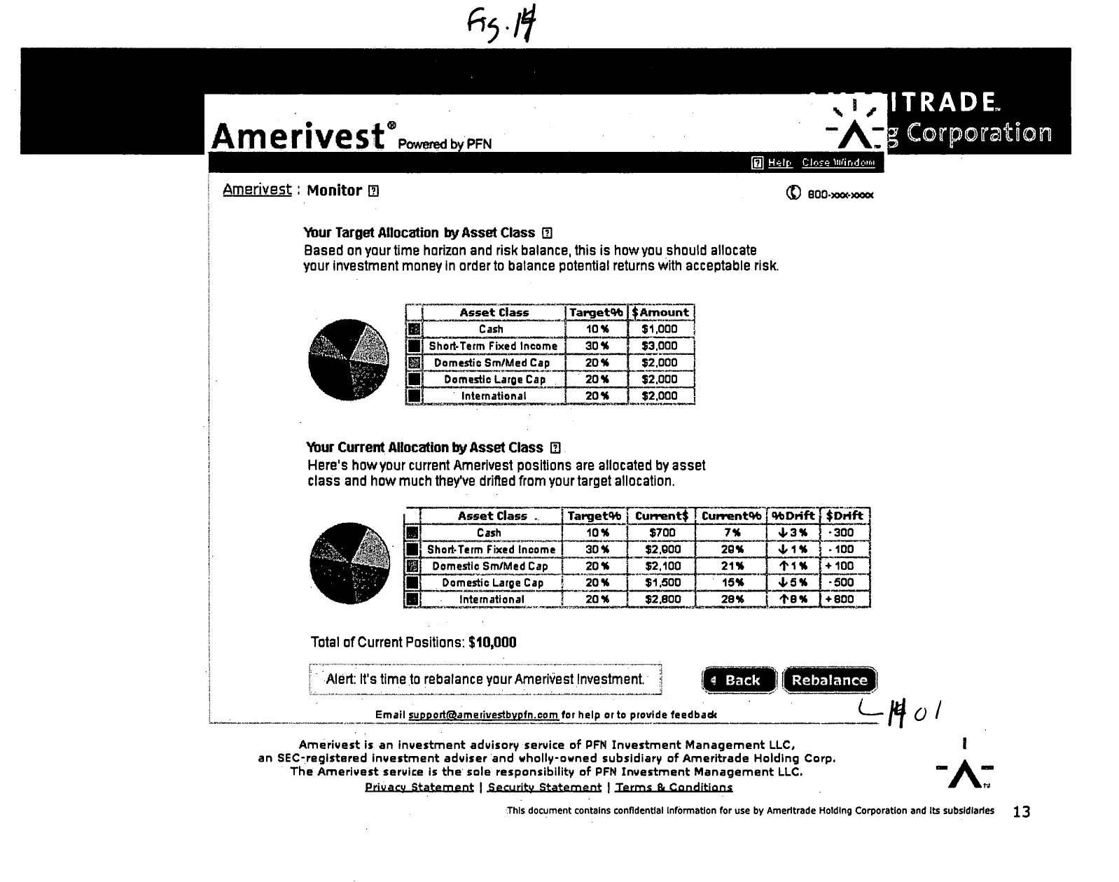

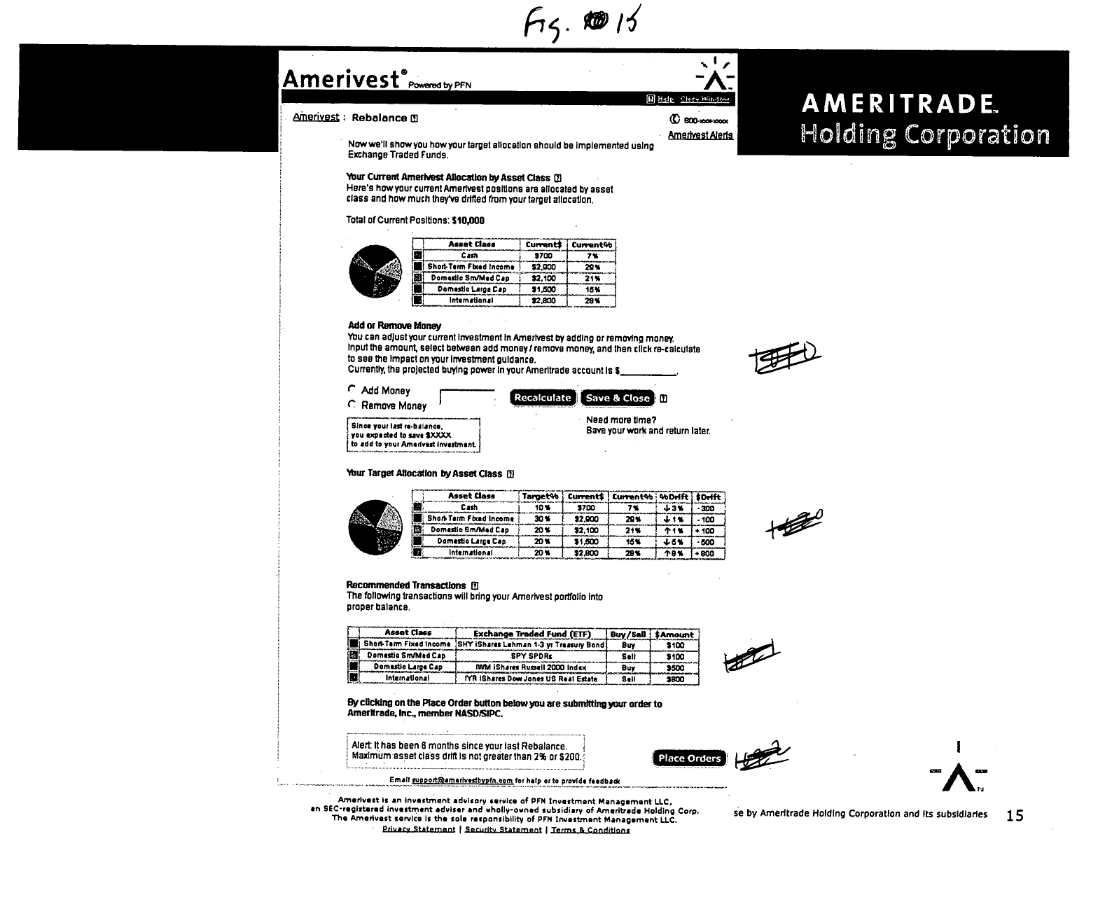

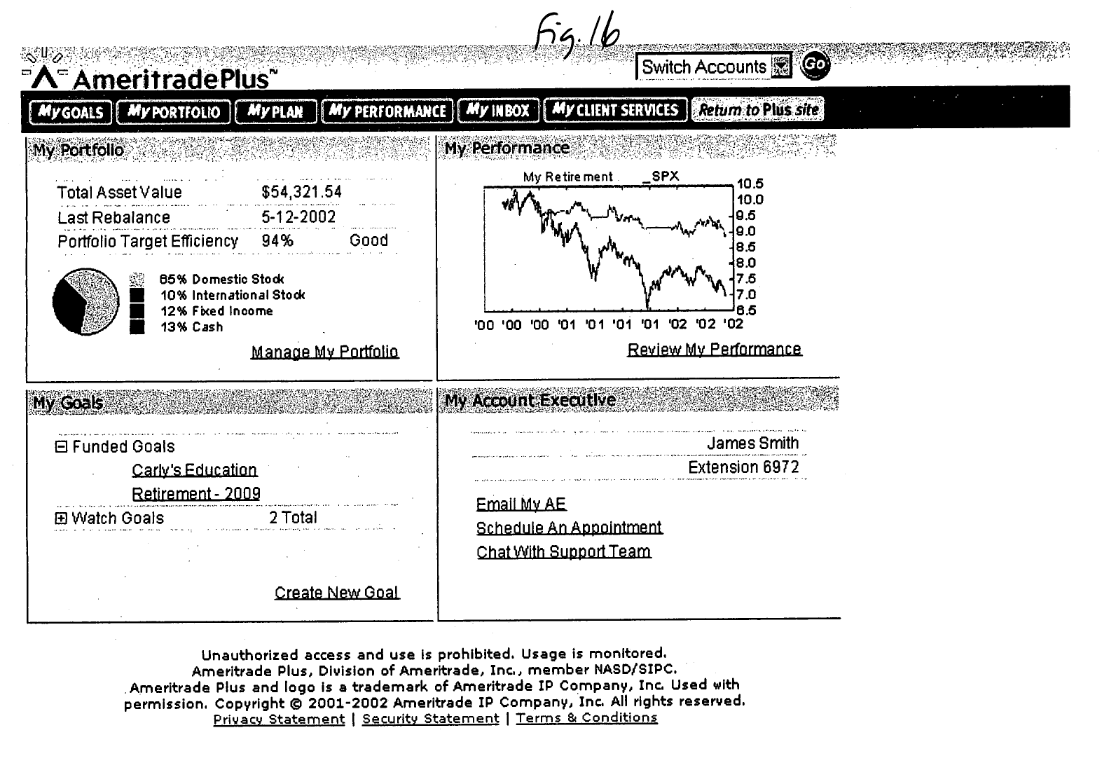

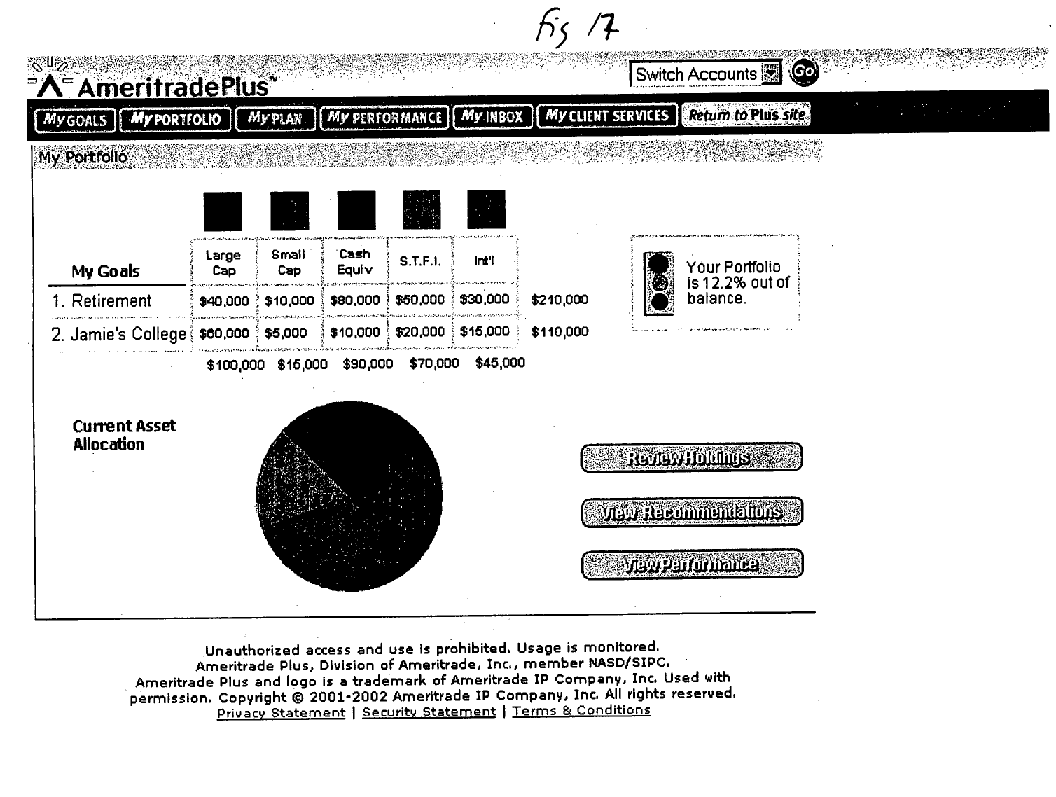

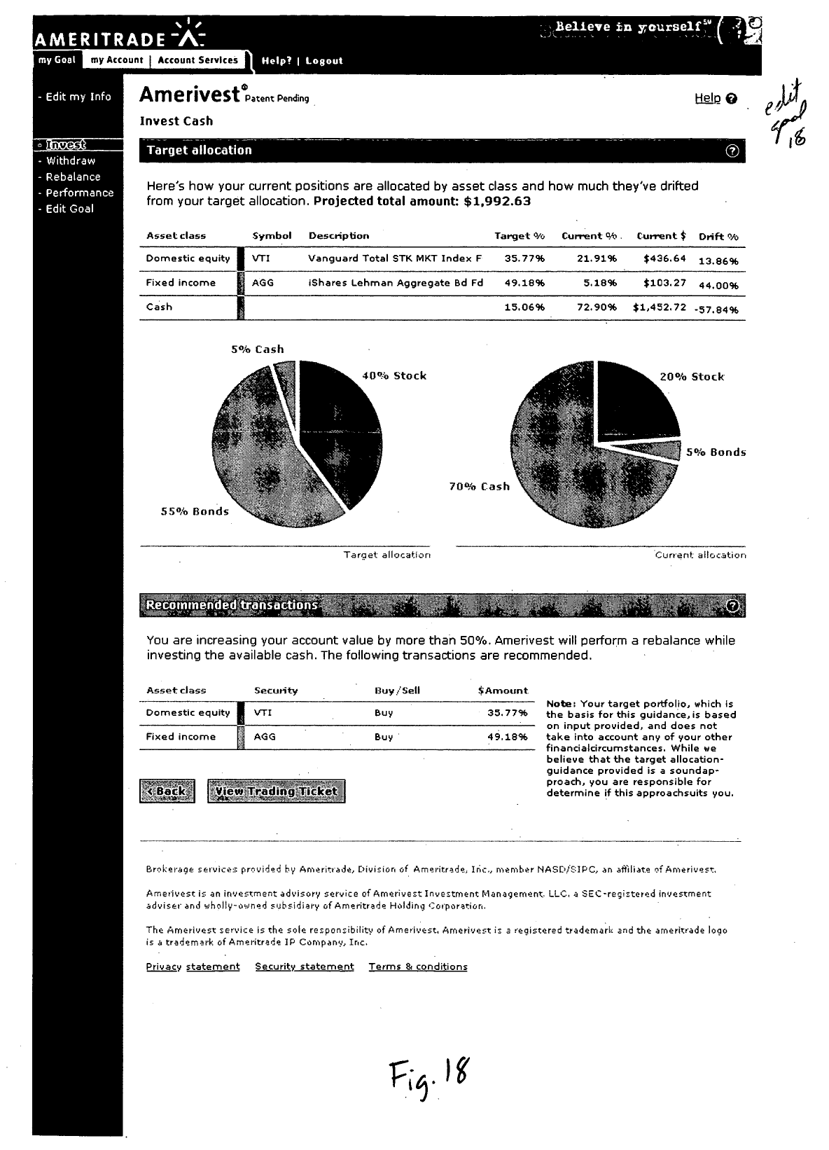

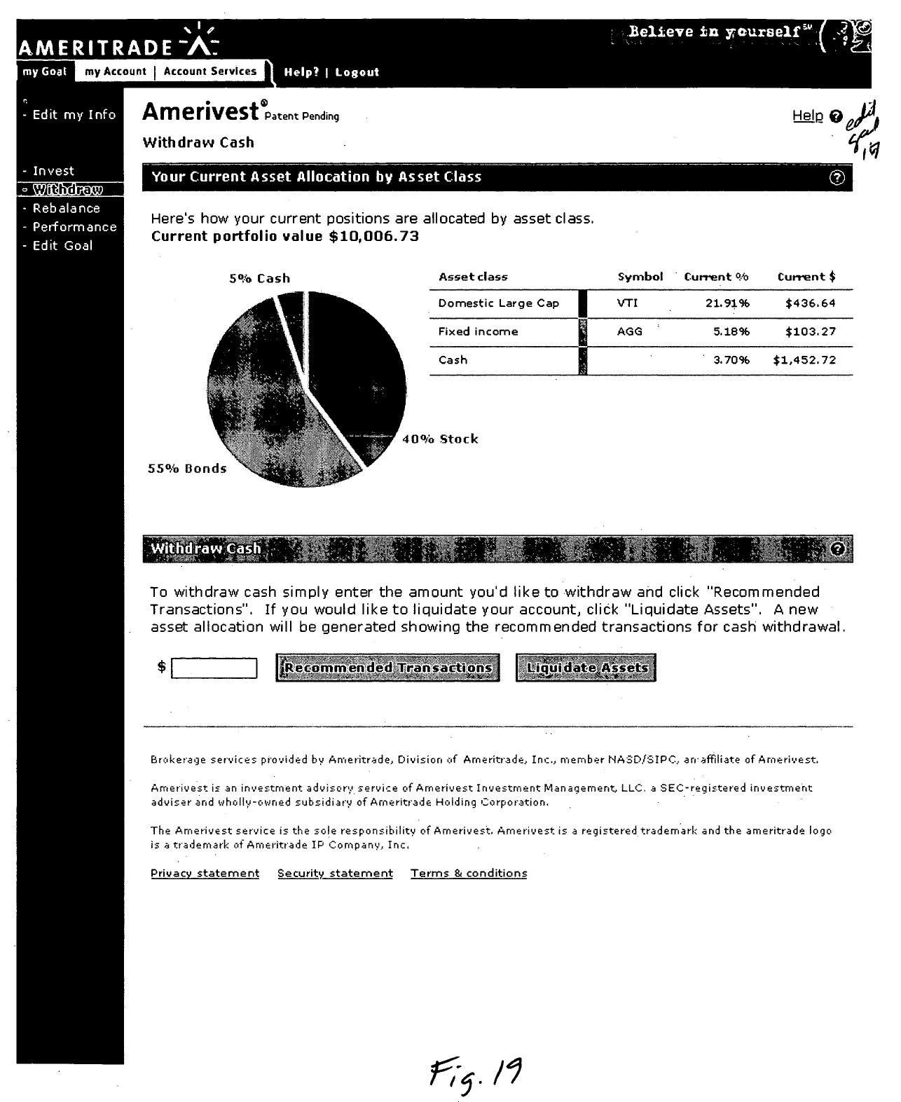

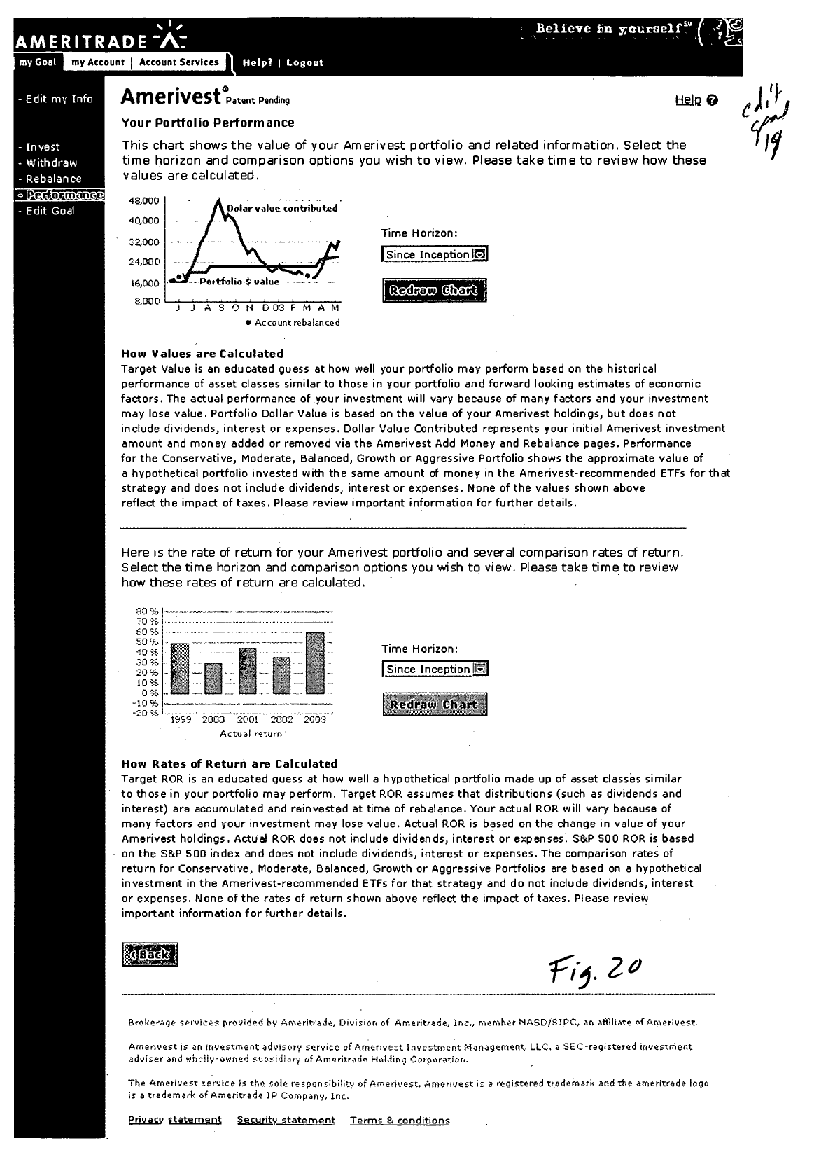

In Subprocess 200, the investor enters certain information that will be used by the system to determine a customized portfolio asset allocation strategy for the investor. The investor may be prompted to enter investment goal information in Subprocess 200. FIG. 2 illustrates an exemplary interface that may be used in Subprocess 200. As shown in FIG. 2, the investor user may be prompted to enter a name 201 for his investment goal. This optional field is used to personalize the goal for the user. Although not shown in FIG. 2, in another embodiment, an investor user may define multiple goals for his investment portfolio.

In addition, the investor may be promoted to define the type of goal, as shown by section 210. As will be apparent to those skilled in the art, additional types of goals are possible, and may be included in the list of goal types. Additional information relating to the portfolio goal may also be entered in Subprocess 206.

In Subprocess 300, the investor enters information that will be used by the system to assess the investor's level of risk tolerance. The risk tolerance level affects the performance of the portfolio over time. A more aggressive risk tolerance level will generally result in a higher investment return over the log term, but riskier investments also tend to fluctuate more in value over the short term.

FIG. 3 illustrates an exemplary interface that may be used in Subprocess 300. As shown in FIG. 3, the investor may be presented with a limited number of risk tolerance levels 301 to select from. In the example shown in FIG. 3, the investor can select a “Conservative”, “Moderate”, “Balanced”, “Growth” or “Aggressive” level of risk. As will be apparent to one skilled in the art, the system could be implemented using either a greater or smaller number of risk levels. Information regarding the potential returns and risks for each category are preferably shown in the interface.

As shown by button 302, in a preferred embodiment the investor user may optionally elect to take a risk tolerance quiz or questionnaire to allow the system to recommend a risk profile according to the investor's answers in the risk tolerance quiz. Many types of risk tolerance quizzes or questionnaires are known to those skilled in the art. FIGS. 4A-4H illustrate one embodiment of a Risk Tolerance questionnaire that may be used to determine a Risk Tolerance level for an investor user.

The system may prompt for further information relating to the investor's portfolio, as shown by the example interface of FIG. 5. As shown, the investor user may be prompted to enter a target year or time horizon 202. If the portfolio goal is retirement, the investor user may be prompted to enter an estimated retirement age 203 and estimated desired monthly retirement withdrawals 204.

As will be apparent to those skilled in the art, additional information could be gathered from the investor user. Many different types of information that could be used to optimize a portfolio's asset allocation toward a defined goal will be known to one skilled in the art and are intended to come within the scope of the present invention.

The inventive system determines the amount of funds that will need to be invested in order to reach the desired goal within the determined risk tolerance level. As shown in FIG. 6, the inventive system preferably allows the investor user to invest all of the funds at once 601, invest some funds up-front and contribute to the portfolio periodically 602, or define a customized contribution scheme 603. Basic information regarding the various funding options may optionally be shown, as shown in chart 605. By allowing the investor to make periodic contributions, the system puts the investor in the frame of mind to bring regular inflows of assets to the investment account, thereby increasing the investor's likelihood of success of reaching his investment goals.

In Subprocess 400, the system determines an optimized portfolio asset allocation scheme based on information entered by the investor in Subprocesses 200 and 300. The asset allocation management system of the present invention preferably provides a listing of particular financial products to be held in the portfolio in order to achieve the desired goal defined by Subprocess 200 within the risk category selected in Subprocess 300.

As is apparent to those skilled in the art, there are many ways of determining an asset allocation strategy. In one embodiment, several asset allocation strategies are predefined, and the system determines which strategy is the most appropriate for the parameters entered and determined in Subprocesses 200 and 300. Optionally, the determination of an asset allocation strategy may be performed by a separate module.

FIG. 7 illustrates an exemplary interface that may be used to display the recommended asset allocation strategy determined by Subprocess 400. As shown in FIG. 7, a graphical view of the target allocation of assets (701) may be displayed. Both pie chart 701 and table 702 illustrate the percentage of funds that are recommended to be invested in each asset class. The illustrated recommended asset allocation strategy shows how the investor user should allocate the investment funds in order to balance the potential returns with this investor's level of acceptable risk so as to reach the target goal.

In the exemplary interface shown in FIG. 7, the example asset allocation strategy is divided between three broad asset classes—cash, bonds and stocks. The recommended asset allocation scheme is to invest the funds as 25% bonds, 75% stocks and 0% cash. Of course, more or fewer asset allocation classes could be used in the recommendation. A more detailed recommended asset allocation is shown in table 702. As shown, the assets are further divided into classes of cash, short-term fixed income bonds, corporate bonds, domestic small, mid and large-cap stocks, and international stocks. As will be apparent to those skilled in the art, any number of methods could be used to display a recommended asset allocation strategy to the investor user, and any number of types of financial products could be used as asset classes in the recommended asset allocation strategy.

As shown in FIG. 8, the inventive system recommends specific financial products to be purchased in order to obtain the recommended asset allocation strategy for the portfolio. In the illustrative interface, Exchange Traded Funds (ETFs) are used to fulfill the recommended asset allocation strategy. As will be apparent to those skilled in the art, different ETFs could be used, or alternatively financial products other than ETFs could be used to fulfill the specific recommended asset allocation strategy.

If the recommended asset allocation is unacceptable to the investor, he is preferably given the option to cancel (button 802), so that he can return to Subprocesses 200 and 300 to change the parameters of the goal or change his risk tolerance level. In addition, the investor is preferably given the option of saving his inputs and recommended asset allocation for future use upon returning to the system.

As shown by button 801, in a preferred embodiment a single button is used to purchase all of the recommended financial products. Unlike other systems that merely provide a recommended portfolio of financial products to purchase, the inventive system provides the ability for the investor to purchase all of the recommended financial products with a single click. To the investor user, it appears that all of the financial products are purchased simultaneously upon clicking a single button (801). In an alternative embodiment, there may be buttons that will execute all of the buys for a defined group of the financial products. For example, there could be two buttons—one to buy all of the recommended stocks and one to buy all of the recommended bonds.

When the investor accepts the recommended asset allocation, he can convert his initial investment into the recommended diversified portfolio with a single click. Unlike other systems, the system of the present invention creates and executes all of the necessary buy (and/or sell) orders without further input from the user. While other systems require the user to create a separate order for each transaction, the system of the present invention makes this processing invisible to the user and performs all transactions automatically.

Subprocess 500 may be initiated by the investor user clicking on the “Place Order” button 801 in FIG. 8. Upon clicking “Place Order” button 801, Subprocess 500 executes the transactions needed to create the recommended diversified portfolio in the background. The inventive system determines appropriate buy (and/or sell) orders to create the diversified portfolio, and executes each buy or sell order without further input from the investor user.

The embodiment shown assumes that the initial investment to the portfolio is cash. However, the investor may use other types of financial products to fund the investment portfolio created by system according to the present invention. For example, the investor may use shares of a particular stock to fund the investment portfolio. If the investor uses stock as his initial funding for the portfolio, the system will first have to sell the initial assets in order to purchase the recommended financial products.

In a preferred embodiment, the system of the present invention takes the investor's initial holdings into account when creating buy and sell orders, thereby avoiding unnecessary transactions. For example, if an investor is using shares of a Vanguard Total Stock Market Index fund to fund the portfolio, and the recommended asset allocation is to have a portfolio consisting of 10% shares of Vanguard Total Stock Market Index fund, 50% shares of Lehman Aggregate Bond Fund and 40% shares of Dow Jones US Real Estate ETF, the system of the present invention will preferably recommend an asset allocation that will use the currently held Vanguard shares. In this example, only the amount of Vanguard shares needed to fund the purchase of the required number of shares of the Lehman bond fund ETF and the Dow Jones US Real Estate ETF is sold. This is preferable to selling all 1000 shares of the Vanguard ETF to fund the initial portfolio, then repurchasing enough Vanguard ETF shares to have 10% of the recommended portfolio consist of the Vanguard ETF shares. Transaction costs are reduced in the present invention as the recommended asset allocation strategy is compatible with the investor's current holdings.

In one embodiment, the system will consider potential tax consequences for the investor when making asset allocation recommendations and executing the recommendation plan. In one embodiment, tax consequences are presented to the user for consideration before executing the recommended asset allocation. FIG. 9 illustrates an example interface that could be presented to the investor user that details potential tax consequences of creating the recommended portfolio. Another embodiment of the “tax aware” feature of the inventive system will be discussed further in the rebalancing section.

In one embodiment, Subprocess 500 is executed without further interaction with the investor user. In another embodiment, a trading ticket is created and presented to the user before being executed. FIG. 10 illustrates an exemplary trading ticket created for a recommended asset allocation. As shown in FIG. 10, in this embodiment, the user is required to approve the execution of the trading ticket before it is executed. As discussed above, the user is presented with a single trading ticket instead of five different trading tickets for each of the financial products, and need only click a single button 1001 in order to execute all of the itemized trades simultaneously without further user input.

The trading ticket shown in FIG. 10 is preferably filled with real-time quotes in a trade preview format. FIG. 11 illustrates an exemplary order receipt interface that may optionally be shown to the user after the order is placed. As shown by FIG. 11, each individual trade is preferably given an order number for confirmation purposes.

As is known to those skilled in the art, an investment portfolio is dynamic, and requires monitoring in order to provide optimal results. There are many reasons for this. First, an investor's goals typically change with time. In addition, an investor's circumstances may change. For instance, an investor may have more money to invest in the investment portfolio than originally predicted, or the investor may not have as much money as anticipated, or may need to withdraw money earlier than predicted.

Therefore, in addition to making the initial purchases required to create the asset portfolio, the asset allocation management system of the present invention allows for monitoring and management of the investor's portfolio.

Rebalancing the portfolio is a task that is generally performed on a periodic basis. A yearly rebalancing of an investor's portfolio is typical, although the rebalancing may be performed either more frequently or less frequently, or at any desired time.

In a preferred embodiment of the present invention, an investor can either choose to be reminded when it is time to rebalance his portfolio, or the investor can choose to have the system automatically rebalance the portfolio at a predetermined regular basis without any user input. When the investor chooses to have the system automatically rebalance the portfolio, the management of the portfolio goes on “auto-pilot,” and the investor can rest assured that his portfolio is being managed without ever having to perform any additional management tasks on his own. In this embodiment, once the investor makes the initial investment, the inventive system will take care of rebalancing the portfolio on regular intervals without any action on the part of the investor. For many of today's passive investors, this is a very useful feature.

If the investor chooses to be reminded when it is time to rebalance the portfolio, the reminder may take the form of one or more emails. For example, if an investor creates an investment portfolio using a system of the present invention on Mar. 1, 2004, the system may send an email reminder to the investor on Feb. 1, 2005 reminding him that it is time to-rebalance the portfolio. If the investor takes no action, additional reminders can be sent on Feb. 15, 2005 and Feb. 28, 2005. Any number and types of reminders can be sent to the investor at desired times.

In one embodiment, the portfolio may automatically be rebalanced after a certain number of reminders are sent without any response from the investor. In another embodiment, the investor can be required to log into the inventive system and manually choose to rebalance the portfolio before the portfolio is rebalanced.

FIG. 12 illustrates an exemplary interface that may be presented to an investor user when he logs back into the inventive system to manage his portfolio. By comparing table 1201 with table 702 in FIG. 7, it is apparent that the illustrative portfolio is no longer in balance. Although not shown in FIG. 12, in one embodiment, the interface may include an alert that will notify the investor that there has been a portfolio drift.

By clicking on the “Rebalance” option 1202, the inventive system may present an interface similar to FIG. 13 to the investor user. As shown in FIG. 13, the current status of the portfolio is shown in section 1310. The previously recommended asset allocation strategy is shown in section 1320. As shown in table 1330, the amount of drift for each asset class is calculated both in percentages and dollar amounts. The inventive system determines the optimal transactions needed to bring the portfolio back into balance, as shown in section 1340. As shown by button 1341, the user can view and execute the trading ticket needed to rebalance the portfolio. As described above in connection with the initial investment funds, in a preferred embodiment a system according to the present invention will take current holdings in the portfolio into consideration when determining what trades are needed to rebalance the portfolio, thereby reducing transaction costs.

FIG. 14 shows an alternative interface for rebalancing a portfolio. In a preferred embodiment, the user is given the opportunity to execute all of transactions itemized in section 1340 by clicking on button 1401. This single click will cause all of the buy and sell transactions needed to rebalance the portfolio to be executed simultaneously. FIG. 15 illustrates yet another embodiment that could be used to display the portfolio drift and allow the investor user to rebalance his portfolio with a single click. FIG. 17 illustrates yet another embodiment of a system according to the present invention that allows the user to define and manage multiple goals.

An additional exemplary monitoring and portfolio management interface are shown in FIG. 16. As shown, the investor user may track performance, manage multiple goals, review historical information about the portfolio and contact an Account Executive.

In a preferred embodiment, additional infusions of funds can be made into the investment portfolio at any time. The additional infusions of funds can be cash, or any other type of financial product. In one embodiment, the system will invest the cash (or other funds) according to the asset allocation strategy determined by Subprocess 400 when the investment portfolio was created. In an alternative embodiment, the additional funds are distributed across the portfolio pro rata to the current holdings in the portfolio at the time the additional funds are invested. In yet another alternative embodiment, additional infusions of funds may cause the portfolio to be rebalanced to account for the increased portfolio size, and are thus distributed across the portfolio in accordance with the rebalanced asset allocation strategy.

In a preferred embodiment the system considers the dollar amount of the additional investment in relation to the value of the existing portfolio when determining how best to distribute the additional funds in the portfolio. For example, a rebalancing threshold may be set. Additional investments that are less than this threshold are deployed “pro rata”. That is, the additional investment is split according to the current portfolio holdings. For example, an investor has a portfolio whose value is $100,000. He invests an additional $3,000 in cash into the portfolio. The additional investment rebalancing threshold is 10%. Therefore, as the addition of $3,000 is less than 10% of the total value of the $100,000 portfolio, the $3,000 is split pro rata. The recommended asset allocation at the time the portfolio was created was 40% bonds, 40% small cap domestic stocks and 20% international stocks. However, the asset allocation in the portfolio has drifted a bit, and the current distribution is 45% bonds, 30% small cap domestic stocks and 25% international stocks. The $3,000 will be split according to the current 45-30-25 distribution. 45% of the $3,000 will be used to purchase the same bond ETFs already held, 30% will be used to purchase the same small cap ETFs and 25% will be used to purchase the same international ETFs. Alternatively, the funds could be distributed according to the original recommended asset allocation strategy of 40-40-20.

If the additional investment is greater than the additional investment rebalancing threshold, the additional investment will cause the system to rebalance the portfolio. Using the example above, if instead of $3,000 in cash the investor is adding bonds worth $50,000, the system will be rebalanced, that is, a new recommended asset allocation strategy for the portfolio will be determined. The new asset allocation strategy will take the additional funds into consideration. In this example, the entire portfolio, including the additional $50,000 bonds, is rebalanced according to the updated asset allocation strategy.

When this type of rebalancing occurs, the additional investment becomes the driver of the automatic rebalancing date. That is, the date of the additional investment becomes the date used to schedule the next rebalancing of the portfolio. Using the example above, the portfolio was created on Mar. 1, 2003, then rebalanced on Mar. 1, 2004. The additional $50,000 is invested on Jul. 1, 2004. The next scheduled rebalancing is Jul. 1, 2005.

FIG. 18 illustrates an example interface that could be used to allow an investor to invest additional funds into the portfolio. As shown in this example, the additional cash to be invested causes the portfolio to be out of balance, and the investor user is allowed to convert the additional cash into financial products recommended in the asset allocation strategy determined by a system according to the present invention.

FIG. 19 illustrates an example interface that could be used to allow an investor to withdraw additional funds from the portfolio. Like investing additional funds,. withdrawing funds from the portfolio may cause the portfolio to be out of balance. In a preferred embodiment, the portfolio may be rebalanced after funds are withdrawn.

FIG. 20 illustrates an interface that could be used by a system according to the present invention to monitor the performance of the portfolio.

An additional feature of the present invention is the ability to manage portfolios that have small, frequent contributions. In these cases, the value of any one contribution may not be enough to purchase the assets needed to meet the recommended asset allocation. In this case, the system allows cash to build up until sufficient funds are present to purchase assets according to the recommended asset allocation scheme.

For example, if the asset allocation scheme requires 15 separate ETFs, and each ETF has a minimum purchase of $1000, periodic small contributions of less than $1000 will not be able to purchase shares of each ETF. The inventive system in this case may purchase $1000 of the ETF with the largest recommended allocation percentage. When the next contribution is invested into the account, the next largest ETF in the asset allocation scheme is purchased, and so on until the portfolio holds at least one share of each ETF. Each contribution buys into the one ETF that will bring the portfolio closest to the optimal allocation. The portfolio is therefore “phased into balance.”

A further feature of the present invention is the ability to perform constrained optimization. For example, an investor may have a sizeable trust fund that is currently untouchable. The inventive system may consider the size and future distribution of this trust fund when determining a recommended asset allocation strategy for the investor's other discretionary funds in the portfolio. As another example, the investor may want to add assets that he does not want to sell to his portfolio. In this case, the system may take these additional funds into consideration when determining a recommended asset allocation strategy, however not use these funds to purchase other assets for the portfolio.

Many different quantitative models could be used to select the ETFs, stocks or other financial products to be used in the portfolio. These models may be based on fundamental quantitative characteristics of the various financial products.

A further feature of the present invention is the ability to execute the trades for rebalancing a portfolio in a tax aware manner. In particular, investors generally like to have short-term losses and long-term gains. For example, stock that is sold less than a year from the purchase date is consdiered “short term.” If the stock is sold at a loss, it is considered a short-term loss, and can be offset against ordinary income up to a certain limit. This is beneficial because the tax rate on ordinary income is higher than the tax on a long-term gain.

A system according to the present invention may execute trade orders taking these matters into consideration. While the exact date that a buy is executed does not particularly matter, the date of sells may be significant. When automatically rebalancing a portfolio on the one-year anniversary, the system may execute loss sell orders on the 364^{th} day after the stock was acquired, while executing gain sell orders on the 365^{th} day after the stock was acquired. Buy orders may be executed on either day. In this manner, the portfolio is rebalanced in a tax efficient manner.

The above described system can be implemented on a computing device, such as a personal computer, PDA, internet enabled telephone, dedicated trading computer, or the like, or a separate programmed general purpose computer having a communications device. Furthermore, the disclosed methods may readily implemented in software using object or object-oriented software environments that provide portable source code that can be used on a variety of computer or workstation platforms. Whether software or hardware is used to implement the systems in accordance with this invention is dependent on the speed and/or efficiency requirements of the system, particular function, and the particular software or hardware systems or microprocessor or microcomputer systems being utilized. The systems and methods described herein can be readily implemented in hardware and/or software using any suitable systems or structures, devices and/or software, such as JAVA®, by those of ordinary skill in the applicable art from the functional description provided herein and with a basic general knowledge of the computer and telecommunications arts.

Moreover, the disclosed methods may be readily implemented in software executed on a programmed general purpose computer, a special purpose computer, a microprocessor, or the like. In these instances, the systems and methods of this invention can be implemented as a program embedded on a personal computer such as a JAVA®, CGI or Perl script, as a resource residing on a server or graphics workstation, as a routine embedded in a dedicated trading system, or the like. The systems and methods of this invention can also be implemented by physically incorporating this system and method into a software and/or hardware system, such as the hardware and software systems of a computer.

While this invention has been described in conjunction with a number of embodiments, it is evident that many alternatives, modifications, and variations are possible in keeping with the basic principles exemplified herein.

1. An portfolio investment management system comprising:
an asset allocation strategy recommendation module adapted to receive investment goal information and investor risk tolerance level information from a user, said investment goal information including at least one of an initial investment amount or estimated contributions, and an estimated withdrawal target date, the asset allocation strategy recommendation module determining a percentage allocation for a plurality of asset classes,
an asset allocation strategy execution module adapted to execute the determined asset allocation strategy, and
a rebalancing execution module adapted to automatically rebalance the portfolio upon a predetermined condition without any further input from the user.

2. The system of claim 1, wherein the predetermined condition is a predetermined date.

3. The system of claim 1, wherein the predetermined date is an anniversary date of the portfolio's creation date.

4. The system of claim 1, wherein the predetermined condition is an additional investment into the portfolio.

5. The system of claim 4, wherein the additional investment is greater than or equal to a predetermined threshold.

6. The system of claim 4, wherein the additional funds are invested pro rata in accordance with the portfolio's asset allocation as of the date of the additional investment.

7. The system of claim 1, wherein the asset allocation strategy execution module executes trade orders in a tax aware manner.

8. A method for portfolio management using an electronic investment management system, comprising:
a. receiving initial investment information from a user, including initial investment amount and financial goal information, into the electronic investment management system;
b. receiving risk tolerance level information from the user into the electronic investment management system;
c. determining a recommended asset allocation strategy for the investment portfolio based on the received investment information and risk tolerance level information;
d. implementing the recommended asset allocation strategy by the investment management system; and
e. automatically rebalancing the portfolio upon a predetermined condition.

9. The method of claim 8, wherein the predetermined condition is a predetermined date.

10. The method of claim 9, wherein the predetermined date is an anniversary date of the portfolio's creation date.

11. The method of claim 8, additionally comprising:
f. receiving additional investment information from the user.

12. The method of claim 11, additionally comprising:
g. automatically rebalancing the portfolio upon receiving the additional investment information.

13. The method of claim 11, wherein the predetermined condition is the additional investment being greater than or equal to a predetermined threshold.

14. The method of claim 11, wherein the additional funds are invested pro rata in accordance with the portfolio's asset allocation as of the date of the additional investment.

15. The method of claim 8, wherein executing the rebalancing step (e) makes trade orders in a tax aware manner.
